(19) United States
(12) Patent Application Publication
(10) Pub. No.: US 2007/0218850 A1
(43) Pub. Date: Sep. 20, 2007

(54) Integrated Tuner for Terrestrial and Cable Television

(76) Inventor: Jianping Pan, San Diego, CA (US)

Correspondence Address: JIANPING PAN, 12925 CAMINITO BESO, SAN DIEGO, CA, 92130, US

(21) Appl. No.: 11/575,803

(22) PCT Filed: Sep. 29, 2005
(86) PCT No.: PCT/US05/34586

§ 371 Date: Mar. 22, 2007

Related U.S. Application Data
(60) Provisional application No. 60/522,523, filed on Oct. 8, 2004.
(60) Provisional application No. 60/522,888, filed on Nov. 18, 2004.
(60) Provisional application No. 60/593,260, filed on Dec. 28, 2004.

(51) Int. Cl. H04B 1/18

(52) U.S. Cl. 455/189.1

(57) ABSTRACT

A highly integrated terrestrial and cable tuner for receiving digital and analog television signals is disclosed. It achieves high performances in sensitivity, image rejection, dynamic range, channel selectivity and power consumption. A major-images rejection converter disclosed rejects third- and fifth-order images. Thus it significantly relaxes RF filter design in a tuner of a single-stage or a first-stage zero-IF/low-IF downconversion architecture. Different architectures and frequency planning are disclosed in accordance with specifications of TV standards to improve the overall performance of the tuner with a different or configurable IF output. The tuner is integrated by using standard processes, with minimal off-chip components excluding SAW and LC filters. Small tuner modules cost less than discrete (can) tuners. They can be used in digital/analog TV sets and portable and handheld TV devices and for mobile-phone TV reception.

### CROSS-REFERENCE TO RELATED APPLICATIONS

This application claims the benefit of U.S. Provisional Patent Application No. 60/522523 filed Oct. 8, 2004; U.S. Provisional Patent Application No. 60/522888 filed Nov. 18, 2004; and U.S. Provisional Patent Application No. 60/593260 filed Dec. 28, 2004; the contents of which are hereby incorporated by reference.

### FIELD OF THE INVENTION

This invention relates to integrated radio frequency (RF) receivers, and more particularly to highly integrated tuners used in terrestrial and cable systems for receiving digital and analog television signals and cable modem signals.

### BACKGROUND OF THE INVENTION

The present invention relates to highly integrated tuners. Such tuners can be applied for receiving any type of television (TV) signal having an analog or digital format from a terrestrial aerial or cable distribution network, and they can be used for cable modem. The frequency band where terrestrial TV channels are allocated is approximately in a range of 50 to 880 MHz. A channel spacing (or roughly bandwidth) of 6 MHz or 8 MHz is adopted around the world. Analog TV standards of NTSC, PAL and SECAM are most popular. The cable TV network uses a frequency band basically similar to the one of the terrestrial TVs. Digital TV systems share the spectrum with the analog TV systems. A cable modem system uses some channels in the TV frequency band for downstream transmission.

The function of a tuner, as an RF receiver, is to amplify an RF signal from an antenna or a cable connector and convert the RF signal into an intermediate frequency (IF) signal. One key issue in tuner design is that the ratio between an overall bandwidth of the frequency band of 50 to 880 MHz and the center frequency is very high. This issue has been significantly influencing integrated tuner architectures and circuit designs.

An integrated tuner in production is a dual-conversion tuner. The frequency of a first IF signal of it is usually in a range of 1.0 to 1.3 GHz. The frequency of an output IF signal is often defined as 44 MHz or 36 MHz. The high-frequency first IF results in much relaxed design of an RF bandpass filter. However it creates an image in the second-stage downconversion which is difficult for a first IF bandpass filter to reject. For a typical image rejection of 50 to 60 dB, a high-quality bandpass filter design is needed, thus it is difficult, if not impossible, to integrate this high-quality bandpass filter on-chip even by using SiGe BiCMOS. Consequently at least one of two surface acoustic wave (SAW) filters in the first IF and output IF is likely needed for image rejection.

Another integrated tuner in use presently is a low-IF single-conversion tuner which has applications in cable systems. In this tuner, image rejection is achieved by an RF polyphase filter and a double quadrature downconverter in conjunction with an IF polyphase filter. By using a low IF of 4 to 5 MHz for a cable application, rather than a common-used IF of 44 or 36 MHz, a better matching performance can be obtained in the downconverter and IF polyphase filter. However, this tuner architecture tends to deliver a moderate image rejection around 50 dB. While the tuner seems acceptable in cable TV/modem applications, it is evidently disadvantageous in meeting stringent terrestrial TV requirements.

Accordingly, it is the objective of this invention to provide a highly integrated, single-chip silicon tuner which can be integrated by using standard processes, like CMOS, BiCMOS and SiGe BiCMOS.

It is another objective of the invention to provide a highly integrated tuner which requires a small number of insensitive external components, without SAW filters, thereby making costs of the tuner modules lower than those of discrete TV tuners in use.

It is yet another objective of the invention to provide a highly integrated tuner which is able to receive analog and digital TV signals in a terrestrial or cable TV system.

It is yet another objective of the invention to provide a highly integrated tuner which is able to achieve high performances in sensitivity, image rejection, dynamic range, channel selectivity, and power consumption.

It is yet another objective of the invention to provide a highly integrated tuner which provides a flexible or configurable IF output interface in order to interface with a wider variety of commercially-available digital and analog demodulators.

### SUMMARY OF THE INVENTION

This invention presents a major-images rejection (MIR) frequency converter which can theoretically provide full cancellation of third- and fifth-order images (and other higher-order images) in the switching converter. As a result, an RF bandpass filter at the RF stage only needs to suppress higher-order images and can be integrated on-chip.

The MIR converter is then applied to a zero-IF direct-conversion tuner and a low-IF single-conversion tuner so that the tuners are able to fully meet performance requirements of different TV standards and to possess advantageous features of low power and small chip size. These tuners are used to interface demodulators having a baseband or low-IF interface.

A dual-conversion tuner architecture of first-stage zero-IF downconversion and second-stage upconversion is disclosed by this invention. The first-stage zero-IF downconversion makes the on-chip design of an RF image rejection filter possible. The second-stage upconversion delivers a flexible output IF to interface a variety of demodulators, and it can also simplify the design of a baseband circuitry. The MIR converter is utilized for the downconversion to further relax the RF filter design.

A dual-conversion tuner architecture of first-stage low-IF downconversion and second-stage upconversion is also disclosed by this invention, for some applications, like a cable TV or cable modem system. The MIR converter is used to relax the RF filter design.

A triple-conversion tuner is disclosed by this invention. It has a first-stage conversion to convert an RF signal to a first high-frequency IF to make design of an RF filter simple, a second-stage zero-IF downconversion to relax design of an IF filter at the first IF, and a third-stage upconversion to provide a common-used frequency of an output IF signal.

### BRIEF DESCRIPTION OF THE DRAWINGS

This present invention will be better understood from the following detailed description. Such description makes reference to the accompanying drawings, in which:

FIG. 1 is a block diagram of a preferred embodiment of an integrated tuner of dual-conversion architecture of the present invention, where a first conversion is a zero-IF downconversion;

FIG. 2 shows an example where the third and fifth harmonics can be cancelled by weighted summing 45° phase-shifted square-wave signals;

FIG. 3 is a semi-schematic diagram of an embodiment of a major high-order images rejection active switching mixer, having a differential signal input, a reference input of three 45° phase-shifted components and a differential output;

FIG. 4 is a semi-schematic diagram of a first embodiment of a major high-order images rejection passive switching mixer, having a differential signal input, a reference input of three 45° phase components and a differential output;

FIG. 5 is a semi-schematic diagram of a second embodiment of a major high-order images rejection passive switching mixer, having a differential signal input, a reference input of three 45° phase-shifted components and a differential output;

FIG. 6 is a preferred embodiment of a double quadrature major images rejection converter having a quadrature signal input, a multi-phase reference input of four phase components and a quadrature output;

FIG. 7 is a simplified schematic diagram of an active switching CMOS mixer which has a differential signal input, a differential reference input and a differential output;

FIG. 8 is a block diagram of a double quadrature converter with an interconnection of four switching mixers, having a quadrature signal input, a quadrature reference input and a quadrature output;

FIG. 9 is a block diagram of a single quadrature converter, with an interconnection of two switching mixers, having a real signal input, a quadrature reference input and a quadrature output, which is hereby denoted as a type-I single quadrature converter;

FIG. 10 is a block diagram of a single quadrature converter, with an interconnection of two switching mixers, having a quadrature signal input, a real reference input and a quadrature output, which is hereby denoted as a type-II single quadrature converter;

FIG. 11A is a schematic diagram of a polyphase filter having a real differential input and a quadrature differential output, and FIG. 11B is a schematic diagram of a polyphase filter having quadrature differential input and output;

FIG. 12 is a semi-schematic diagram of a stage of a multi-stage operational amplifier based complex bandpass filter;

FIG. 13 is a block diagram of a four-phase LO (or reference) signal generator;

FIG. 14 illustrates waveforms of signals in the four-phase LO signal generator;

FIG. 15 is a block diagram of another preferred embodiment of an integrated tuner of dual-conversion architecture of the present invention, where a first conversion is a zero-IF downconversion;

FIG. 16 is a preferred embodiment of a type-I single quadrature major images rejection converter having a real signal input, a multi-phase reference input of four phase components and a quadrature output;

FIG. 17 is a block diagram of a preferred embodiment of an integrated tuner of zero-IF direct-downconversion architecture of the present invention;

FIG. 18 is a block diagram of another preferred embodiment of an integrated tuner of zero-IF direct-downconversion architecture of the present invention;

FIG. 19 is a block diagram of a preferred embodiment of an integrated tuner of low-IF single-downconversion architecture of the present invention;

FIG. 20 is a second preferred embodiment of a type-I single quadrature major images rejection converter having a real signal input, a multi-phase reference input of four phase components and a quadrature output;

FIG. 21 is a block diagram of another preferred embodiment of an integrated tuner of low-IF single-downconversion architecture of the present invention;

FIG. 22 is a block diagram of a preferred embodiment of an integrated tuner of dual-conversion architecture of the present invention, where a first conversion is a low-IF downconversion;

FIG. 23 is a block diagram of another preferred embodiment of an integrated tuner of dual-conversion architecture of the present invention, where a first conversion is a low-IF downconversion; and

FIG. 24 is a block diagram of a preferred embodiment of an integrated tuner of triple-conversion architecture of the present invention.

### DETAILED DESCRIPTION OF THE INVENTION

This invention is to provide a highly integrated silicon tuner which is implemented on a single integrated circuit. However, uses of some external components in the integrated tuner or on the module of it are obviously allowable and may result in an equivalent and slightly better circuit performance. The differential circuit design is used in this invention in all the circuits wherever it is suitable to reject the common-mode sources and even-order nonlinear distortions, and therefore, all issues related to even-order nonlinear distortions and even-number harmonics should be addressed mainly by careful differential circuit designs and proper layout techniques.

The following definitions and representations are used in this context which also covers the section of claims. A quadrature signal represents a complex signal which has an in-phase component and a quadrature component, In a quadrature-signal processing circuit block, I represents an in-phase component or path and Q a quadrature component or path. A total I/Q mismatch is conveniently defined to represent an equivalent total of I/Q amplitude mismatch and phase error. The total I/Q mismatch satisfies the relationship of A=20log₁₀(B), where B in percentage is the total I/Q mismatch, and A in decibel (dB) is a frequency-crosstalk of a mirror signal to a desired signal. A frequency band represents a frequency range where a radio frequency (RF) signal being received is located. The regular frequency bands in terrestrial TV systems and cable networks are approximately from 50 to 880 Mega-Hertz (MHz). An extended frequency band in cable networks is approximately from 40 MHz to 1 Giga-Hertz (GHz). A channel spacing (a distance between two adjacent channels) in the frequency band is typically 6, 7 or 8 MHz but may be smaller, like for a radio broadcast signal of audio. A local oscillator (LO) signal and a reference signal are equivalent, a reference (or LO) signal represents a reference (or LO) signal of square-wave form, and a frequency of a reference (or LO) signal represents a fundamental frequency of the reference (or LO) signal of square-wave form. A mixer represents a subtractive switching mixer using a square-wave reference (or LO) signal. A converter represents a frequency converter based on subtractive switching mixers and using a real or quadrature reference (or LO) signal, of square-wave form. Three types of conventional quadrature converters in the art will be used later, that is, a double quadrature converter having a quadrature signal input, a quadrature reference input and a quadrature output, a type-I single quadrature converter having a real signal input, a quadrature reference input and a quadrature output, and a type-II single quadrature converter having a quadrature signal input, a real reference input and a quadrature output. A quadrature converter is often conveniently used to represent one of these three quadrature converters. A frequency or a center frequency of an intermediate frequency (IF) signal represents the center frequency of a desired signal in the IF signal.

In a conventional downconverter in the art, switching mixers which use square-wave reference signals are typically used for achieving large-signal linearity. As a sequence, the downconverter, having a square-wave reference signal, not only converts a desired signal in an RF signal to an IF, but also mixes some other unwanted signals in the RF signal with harmonics of the reference signal into a narrow range at a center frequency of the IF signal, being superimposed on the desired signal in the IF signal. Because these high-order mixing products have the same effect as an image on the desired signal in the IF signal, the unwanted signals in the RF signal corresponding to these high-order mixing products are hereby termed as high-order images. Note that a high-order hereby means an odd- or even-number order higher than the first-order. For example, the third- and fifth-order images being mixed respectively with the third and fifth harmonics of a reference signal are converted to the IF signals. Accordingly an ordinarily-defined image is hereby called as a (first-order) image, a first-order image or simply an image. Here are two simple examples. First, assume that there is a zero-IF downconverter converting an RF desired signal to a baseband signal. The center frequency of the RF desired signal is 100 MHz. Then a square-wave reference signal of 100 MHz is applied to the zero-IF downconverter, which has third and fifth harmonics of 300 MHz and 500 MHz, respectively. In this example, the third- and fifth-order images locate respectively at 300 MHz and 500 MHz. Second, assume that there is a low-IF downconverter, with a high-side LO injection, converting an RF desired signal to an IF signal of 20 MHz. The center frequency of the RF desired signal is 80 MHz. Then a reference signal of 100 MHz is applied to the low-IF downconverter, which has third and fifth harmonics of 300 MHz and 500 MHz, respectively. In this example, there are two third-order images located at 280 MHz and 320 MHz, and two fifth-order images at 480 MHz and 520 MHz. Note that as said, the issues related to even-number harmonics of reference signals, that is, even-number high-order images should be addressed mainly by careful differential circuit designs and proper layout techniques.

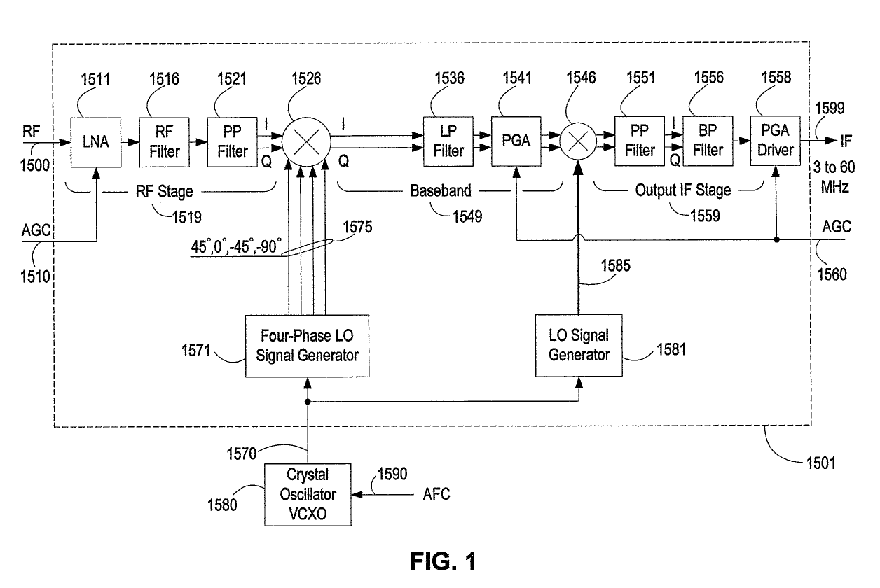

FIG. 1 presents a preferred embodiment of an integrated tuner of dual-conversion architecture 1501 in accordance with the present invention. A low noise amplifier (LNA) 1511 first amplifies an RF signal 1500. The gain of LNA 1511 is switched by an external automatic gain control (AGC) signal 1510. An RF bandpass (BP) filter 1516 attenuates the high-order images in a downconversion 1526 and some strong interference signals causing nonlinear distortions in circuits. An RF polyphase filter 1521 suppresses sidebands of images which are opposite, in frequency, to the wanted sideband of a desired signal in RF signal 1500, and these images are the (first-order) image and third- and seventh-order images, for example. RF polyphase filter 1521 intrinsically converts a real input to a quadrature output. Downconversion 1526 is a single sideband zero-IF downconversion which only downconverts the wanted sideband of the desired signal to baseband 1549. In this context, it is conveniently assumed that the negative sideband is the wanted sideband. This invention presents a major-images rejection (MIR) converter for RF receivers. The present zero-IF double quadrature MIR downconverter is applied to downconversion 1526 to provide rejection of both the (first-order) image and the third- and fifth-order images. As a result, RF BP filter 1516 may only need to reject the ninth-order image (and higher-order images) rather than the fifth-order image when using a conventional zero-IF double quadrature image rejection (IR) downconverter. Note these two facts: (a) the offset of a ninth-order image from the desired signal is twice that of a fifth-order image; (b) the inherent attenuation (−19 dB) of the ninth-order image is 5 dB more than that (−14 dB) of the fifth-order image. Therefore, the present zero-IF MIR downconverter 1526 has an advantage of significantly relaxing design requirements of RF filters in RF stage 1519. It generally leads to a significant improvement on dynamic range of RF BP filter 1516, which is critical in terrestrial tuners where larger interferences exist both in and above the frequency band and in cable tuners to cope with the composite triple beats (CTB) and composite second-order (CSO) beats. After zero-IF downconversion 1526, a baseband lowpass (LP) filter 1536 provides channel selectivity and interference suppression, or it only provides a relaxed anti-aliasing filtering for a second-stage upconversion 1546. A programmable gain amplifier (PGA) 1541 may be assigned to perform AGC functionality fully or partially in baseband stage 1549. Baseband desired signal 1549 is upconverted by a double quadrature upconverter 1546 to an output IF 1559. The center frequency of output IF 1559 may be defined as a popular frequency of around 44 MHz or 36 MHz (often as 43.75 MHz for NTSC and 36.125 MHz for PAL). An IF polyphase filter 1551 attenuates a sideband of the dominant third-order mixing product in switching upconverter 1546. A bandpass filter 1556, in cooperation with baseband lowpass filter 1536, may only need to suppress the high-order mixing products from upconversion 1546 or provide channel selectivity and interference suppression. A PGA in a PGA/Driver 1558 provides AGC functionality, in cooperation with baseband PGA 1541, controlled by an external AGC signal 1560. A driver in PGA/Driver 1558 provides an adequate interface for demodulators of different applications. A four-phase LO signal generator 1571 provides a four-phase reference signal 1575. A quadrature LO signal generator 1581 provides a quadrature reference signal 1585. A crystal oscillator 1580 generates a reference-source frequency 1570. It may be fine-tuned by an external automatic frequency control (AFC) signal 1590.

Operational concept and advantages of the dual-conversion architecture: the first-stage zero-IF downconversion and the second-stage upconversion, of tuner 1501 are described first.

In FIG. 1, in first-stage zero-IF downconversion 1526, the (first-order) image at RF stage 1519 is the desired signal itself. More specifically, the image is the unwanted (positive) sideband of RF desired signal 1519, and it mirrors to the wanted (negative) sideband. This (first-order) image can be rejected relatively easily by using RF polyphase filter 1521 and zero-IF downconverter 1526. Therefore, benefited from zero-IF downconversion 1526, RF BP filter 1516 releases from the difficult task( of rejecting the (first-order) image, so it only needs to attenuate the high-order images and other strong interferences. The use of zero-IF downconversion 1526 consequently provides a good opportunity of integrating RF BP filter 1516 on chip using a low-quality filter design. Furthermore, zero-IF double quadrature MIR downconverter 1526 is presented to further relax the design constraint of RF BP filter 1516 and significantly improve the dynamic range of the circuitry in RF stage 1519.

While effectively leveraging the benefit from the zero-IF downconversion, the present invention defines the unique architecture of this dual-conversion tuner 1501 in FIG. 1 by defining baseband stage 1549 as the middle IF stage followed by final, output IF stage 1559. This architecture relaxes the design constraint of baseband circuitry 1549 and thus maximizes the flexibility of providing effective solutions to cope with the zero-IF related issues like direct current (DC) offset and I/Q mismatch. Final-stage upconversion 1546 provides a flexible center frequency of output IF 1599 to interface analog/digital modulators with different IF frequencies. This unique architecture provides the following advantages as compared to a conventional zero-IF direct-conversion receiver architecture (where the baseband is the final IF stage). Baseband LP filter 1536, at minimum, may perform a relaxed anti-aliasing filtering for upconversion 1546 rather than a more difficult task of channel selection and interference suppression. The use of double quadrature upconverter 1546 further reduces the design constraint of baseband LP filter 1536. The relaxed design of baseband filter 1536 improves the quadrature matching performance. Furthermore, the uses of final, output IF stage 1559 and functional circuits in it reduce the gain requirement in baseband 1549, and only a relatively small gain (10 to 30 dB) is necessary. Thus the impact of the DC-offset, generated in both baseband circuitry 1549 and zero-IF downconverter 1526, on linear operation of baseband circuitry 1549 is significantly reduced. Note that on the other hand, in a conventional zero-IF direct-conversion receiver where the baseband is the final IF stage, a baseband LP filter is required to perform more difficult channel selection and interference suppression while keeping a specified quadrature matching performance, a baseband AGC amplifier typically has a voltage gain of 40 dB (100 in the linear scale) or more at a maximum gain setting, the input-referred DC-offset being significantly amplified when passing through the baseband.

Channel quality in a terrestrial network is influenced by transmission distance and channel types. Typically a demodulator of a cable system can obtain higher Carrier-to-Noise (C/N) ratio, and the cable system can transmit data of higher rates. C/N ratio thresholds, at the IF outputs of RF receivers, for different data-rate demodulations are recommended by digital terrestrial TV standards, like the European DVB-T specification and the US digital TV standard, ATSC. A C/N ratio threshold is defined based on the criteria of a significant low bit error rate (BER) or an equivalent in a digital demodulator. Several maximum C/N thresholds are sampled as follows. The European DVB-T specification (ETSI EN 300 744) recommends the C/N thresholds of about 20 dB for the Gaussian channel, 21 dB for the Ricean channel and 28 dB for the Rayleigh channel at the highest-rate modulation (64-QAM, code rate of ⅞), based on the condition of Quasi Error Free (QEF), BER=10⁻¹¹, after the Reed-Solomon decoding. The US digital TV standard, ATSC, recommends the C/N threshold of about 15 dB for the terrestrial TV broadcast mode, based on the Threshold of Visibility (TOV) of errors, segment error rate of 1.93×10⁻⁴, after the Reed-Solomon decoding. Cable system specifications, Data-Over-Cable Service Interface Specifications (DOCSIS) and OpenCable Specifications, typically specify C/N ratios and receive signal levels at the RF inputs of RF receivers, based on the condition of BER=10−⁸, after the FEC decoding. Then C/N ratio thresholds at an IF output of an RF receiver can be derived from the C/N ratios and receive signal levels at the RF input of the RF receiver when its noise figure is known. The DOCSIS specifications specify the C/N ratios of 33 dB and 34.5 dB (at the lower input receive signal level ranges) respectively for channel spacing of 6 MHz and 8 MHz, at the highest-rate modulation. Note that required C/N ratios in analog TV systems, especially in cable systems, are likely higher. The C/N thresholds can be used as guidelines in specifying an internal I/Q matching performance of zero-IF downconverter 1526 and an I/Q matching performance of baseband circuitry 1549 in FIG. 1.

In zero-IF double quadrature MIR downconverter 1526, the image is the unwanted (positive) sideband of RF desired signal 1500. This image is hereby denoted as self-image, having the same power as RF desired signal 1500. Due to the internal I/Q match imperfection of zero-IF MIR downconverter 1526, after downconversion, a suppressed frequency-inverted version of the wanted sideband of RF desired signal 1500, as a crosstalk signal, is superimposed on the desired signal in baseband 1549. Since the signals of digital standards can be approximately modeled as additive white Gaussian noise (AWGN), the suppressed AWGN-like crosstalk signal is added to the desired signal in baseband 1549. As a consequence, the C/N ratio in baseband 1549 is degraded by this additive noise. Hence, the (first-order) image rejection performance of zero-IF MIR downconverter 1526 depends on both the self-image rejection and this crosstalk rejection. It is relatively easy to reject the self-image by using RF polyphase filter 1521 and zero-IF double quadrature MIR downconverter 1526. Then, the (first-order) image rejection performance of zero-IF MIR downconverter 1526 is dominated by the crosstalk rejection performance. As an example, the (first-order) image rejection specification of zero-IF MIR downconverter 1526 can be such defined that it can achieve, at a maximum gain, an image level in baseband 1549 about 12 dB lower than the noise floor according to a specified C/N ratio threshold, resulting in a degradation of about 0.25 dB at the C/N ratio in baseband 1549. For instance, in the DVB-T specification, the C/N threshold for the case of 64-QAM and code rate of ⅞ for Gaussian channel is 20 dB, then the image rejection of zero-IF MIR downconverter 1526 may be specified as around 32 dB or higher. The internal I/Q matching specification could be around 1.0%, depending on digital cable/terrestrial TV applications. For analog cable/terrestrial TV applications, the internal I/Q matching specification is likely tighter.

The following paragraphs provide detailed description of operation, designs and advantages of the circuit blocks in dual-conversion tuner 1501 in FIG. 1, along with more details regarding the architecture. The four-digit reference numerals with 15 in the left-most two digits identify the circuit blocks and signals in tuner 1501 in FIG. 1.

LNA 1511 boosts a weak RF desired signal at RF input 1500 from a terrestrial aerial or a cable distribution network. Strength and variation of input signal 1500 are significantly different between a terrestrial TV system and a cable network. LNA 1511 typically has a noise figure of 2 to 3.5 dB and a maximum gain up to 25 dB with at least two gain settings of 10 to 20 dB difference, programmed by AGC signal 1510. It should provide satisfactory second-order and third-order input intercept points (IIP2 and IIP3). In a cable network, LNA 1511 block may have an attenuator cascaded with a LNA amplifier. Note that design of LNA 1511 needs to meet stringent specifications on third- and second-order nonlinear distortions for different applications, Signal strength detectors are optionally placed in RF stage 1519 to locally control the gain and attenuation in LNA 1511 in case unexpected strong interferences occur. LNA 1511 may interface with a diplexer in a cable modem or a splitter in a system with more than one RF receiver.

Description of zero-IF double quadrature MIR downconverter 1526 is provided below before RF bandpass filter 1516 and RF polyphase filter 1521, because designs of the two filters are highly related to image rejection characteristic of downconverter 1526.

This invention presents a converter which is able to provide rejection of major high-order images in RF receivers, in any RF receivers for terrestrial, cable, wireless, etc. applications. Major high-order images are hereby termed to represent several lowest high-order images, and major odd-number high-order images are hereby termed to represent several lowest odd-number high-order images, preferably as, third-, fifth-, seventh- and ninth-order images. One objective of this invention is to provide this converter with a better image rejection capacity than those of conventional image rejection converters in the art. The present converter can be applied to the first embodiment of integrated tuner 1501 and other embodiments presented later to significantly relax design constraints and improve dynamic ranges of amplifier and filter circuit blocks in RF stage 1519.

It is obvious in concept that the third- and fifth-order images do not exist in a linear mixer when a reference signal applied to do not have the third and fifth harmonics. A (real) reference signal without the third and fifth harmonics can be constructed from three 45° phase-shifted (or phase) square-wave signal components. Furthermore, a quadrature reference signal without the third and fifth harmonics can be constructed from four 45° phase square-wave signal components and expressed as

$$\begin{matrix}{LO}_{45} = \frac{2 \sqrt{2}}{π} \{ \begin{matrix}( cos ( {ω}_{LO} t ) - sin ( {ω}_{LO} t ) ) + \\ \frac{1}{3} ( cos ( 3 {ω}_{LO} t ) + sin ( 3 {ω}_{LO} t ) ) - \\ \frac{1}{5} ( cos ( 5 {ω}_{LO} t ) - sin ( 5 {ω}_{LO} t ) ) - \\ \frac{1}{7} ( cos ( 7 {ω}_{LO} t ) + sin ( 7 {ω}_{LO} t ) ) + …\end{matrix} \} & ( 1 ) \\ {LO}_{0} = \frac{4}{π} \{ cos ( {ω}_{LO} t ) - \frac{1}{3} cos ( 3 {ω}_{LO} t ) + \frac{1}{5} cos ( 5 {ω}_{LO} t ) - \frac{1}{7} cos ( 7 {ω}_{LO} t ) + … \} & ( 2 ) \\ {LO}_{- 45} ( t ) = \frac{2 \sqrt{2}}{π} \{ \begin{matrix}( cos ( {ω}_{LO} t ) + sin ( {ω}_{LO} t ) ) + \\ \frac{1}{3} ( cos ( 3 {ω}_{LO} t ) - sin ( 3 {ω}_{LO} t ) ) - \\ \frac{1}{5} ( cos ( 5 {ω}_{LO} t ) + sin ( 5 {ω}_{LO} t ) ) - \\ \frac{1}{7} ( cos ( 7 {ω}_{LO} t ) - sin ( 7 {ω}_{LO} t ) ) + …\end{matrix} \} & ( 3 ) \\ {LO}_{- 90} ( t ) = \frac{4}{π} \{ sin ( {ω}_{LO} t ) + \frac{1}{3} sin ( 3 {ω}_{LO} t ) + \frac{1}{5} sin ( 5 {ω}_{LO} t ) + \frac{1}{7} sin ( 7 {ω}_{LO} t ) + … \} & ( 4 ) \\ \begin{matrix}{LO}_{I} ( t ) = {LO}_{45} ( t ) / \sqrt{2} + {LO}_{0} ( t ) + {LO}_{- 45} ( t ) / \sqrt{2} \\ = 2 \frac{4}{π} \{ cos ( {ω}_{LO} t ) - \frac{1}{7} cos ( 7 {ω}_{LO} t ) + … \}\end{matrix} & ( 5 ) \\ \begin{matrix}{LO}_{Q} ( t ) = {LO}_{- 45} ( t ) / \sqrt{2} + {LO}_{- 90} ( t ) - {LO}_{45} ( t ) / \sqrt{2} \\ = 2 \frac{4}{π} \{ sin ( {ω}_{LO} t ) + \frac{1}{7} sin ( 7 {ω}_{LO} t ) + … \}\end{matrix} & ( 6 )\end{matrix}$$

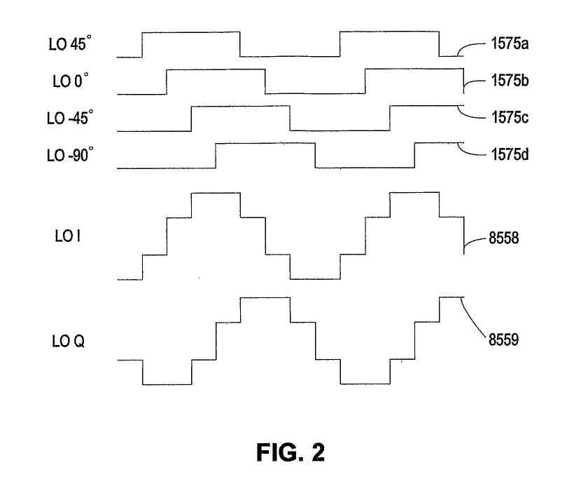

In Equations (1)-(6), LO₄₅(t), LO₀(t), LO₋₄₅(t) and LO₋₉₀(t) represent four 45° phase (square-wave) signal components, illustrated as waveforms 1575a-d in FIG. 2. LO I and Q signals LO_{I}(t) and LO_{Q}(t), as waveforms 8558, 8559 in FIG. 2, do not have the third and fifth harmonics, which are cancelled by the weighted summations of three 45° phase square-wave signal components in Equations (5) and (6), respectively. Note that in this context, a degree is conveniently used to denote a phase of (this degree×2π/360°), for example, a 45° phase denotes the π/4 phase. Equations (1)-(6) and FIG. 2 show, in formulas, an example how to generate a quadrature reference signal in which the third and fifth harmonics are cancelled by using four 45° phase square-wave signal components. However, in a switching mixer, a reference signal acts as a two-level switching signal, so multi-level reference signals like LO_{I}(t) and LO_{Q}(t), waveforms 8558 and 8559, cannot be accepted. An equivalent method of canceling the third- and fifth-order images is then provided by performing the weighted summations of Equations (5) or (6) in a quadrature converter somewhere in the I/Q signal paths. This kind of quadrature converter is hereby termed as a quadrature major-images rejection (MIR) converter, as presented as follows, rejecting not only the (first-order) image but also the third- and fifth-order images.

A preferred embodiment of a double quadrature MIR converter is based on a major high-order images rejection (MHOIR) switching mixer, which can also be considered as a real MIR converter having a real signal input and a real output and rejecting the third- and fifth-order images. Three preferred embodiments of the MHOIR switching mixer are described next.

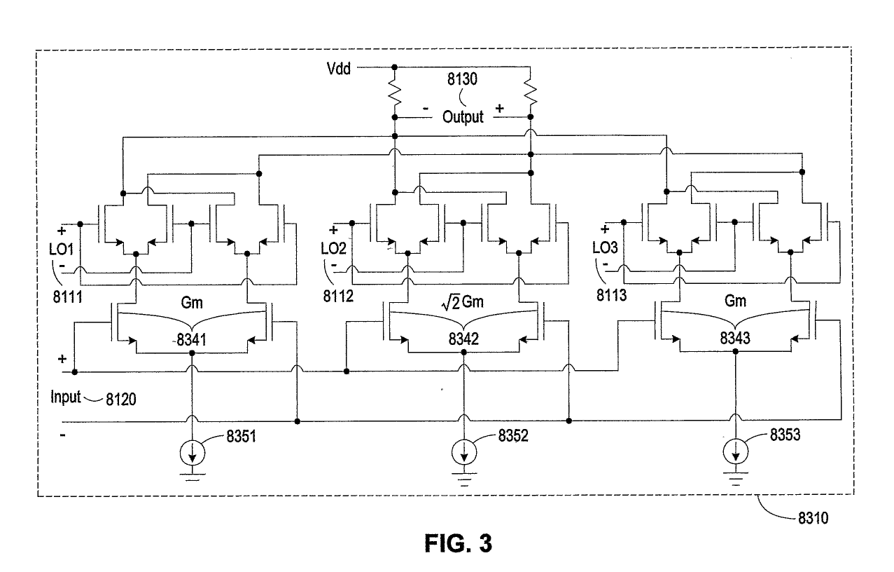

A first preferred embodiment 8310 of the MHOIR switching mixer shown in FIG. 3 is based on conventional active switching mixers. MHOIR active switching mixer 8310 consists of three active switching mixers. It has a (differential) signal input 8120 and a reference (or LO) input having three 45° phase(-shifted) components 8111, 8112 and 8113. MHOIR active switching mixer 8310 implements the weighted summation of three 45° phase-shifted mixing signals at output 8130. The third- and fifth-order images (and some other odd-number higher-order images, for instance, the eleventh- and thirteenth-order images) are consequently cancelled at output 8130. When MHOIR active switching mixer 8310 delivers an equivalent function of Equation (5), three 45° phase components LO1 8111, LO2 8112 and LO3 8113 of the reference input have components LO 45° 1575a, LO 0° 1575b and LO −45° 1575c of the 45° phase reference signal in FIG. 2, respectively. When MHOIR active switching mixer 8310 delivers an equivalent function of Equation (6), LO1 8111, LO2 8112 and LO3 8113 have components LO −45° 1575c, LO −90° 1575d and inversion of LO 45° 1575a of the 45° phase reference signal, respectively. Note that the inversion of LO 45° is a LO of −135° equivalently. The weighted summation in Equation (5) or (6) is executed in MHOIR active switching mixer 8310 by defining the transconductance (Gm) values of input stages 8341, 8342 and 8343 as Gm, √2Gm and Gm, respectively. The Gm values can be controlled in several ways, for example, using the W/L ratios of input stages 8341, 8342 and 8343, and current sources 8351, 8352 and 8353. Output 8130 provides a mixing result with theoretically full cancellation of the third- and fifth-order images. It should be noted that ratios of the gains (Gm values) of the three mixers should specifically satisfy Equation (5) or (6) in order to achieve the theoretically full cancellation of the third- and fifth-order images, otherwise, for example, when the three mixers are defined to have a same gain, then a summation of the outputs of the three equal-gain mixers can only provide a small attenuation of 15.3 dB, rather than the theoretically full cancellation, on the third- and fifth-order images.

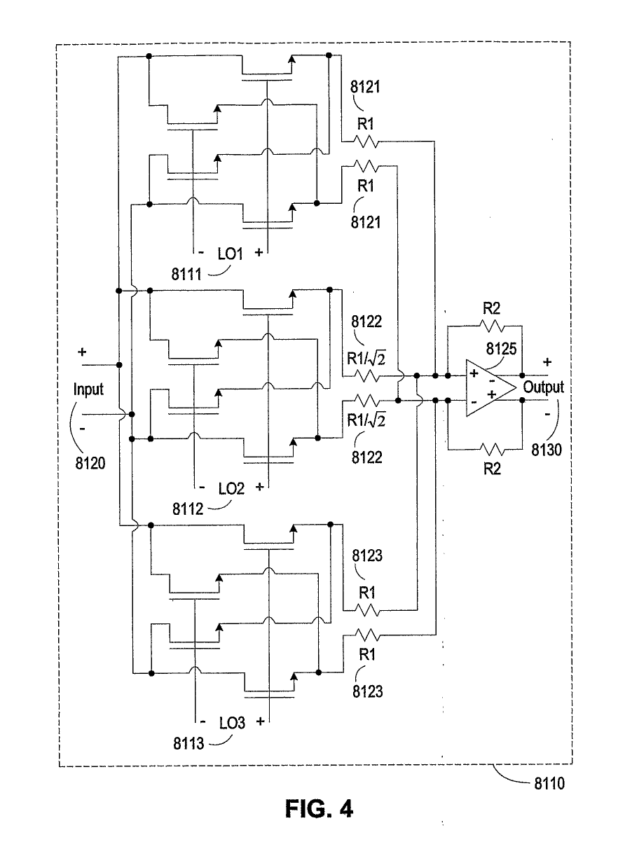

A second preferred embodiment 8110 of the MHOIR switching mixer shown in FIG. 4 is based on conventional passive mixers. MHOIR passive switching mixer 8110 comprises three prior art passive mixers, which are identical here. It has a signal input 8120 and a reference (or LO) input having three 45° phase components 8111, 8112 and 8113. The outputs of the mixers are summed by operational amplifier (OpAmp) 8125 based weighted summer. Note that in this context, in a weighted summer, a weight of an input indicates that the weight corresponds to the signal path of this input and multiplies the input signal before the summation. The weighted summation in Equation (5) or (6) is executed in weighted summer 8125 by defining weights of three inputs, that is, input resistors 8121, 8122 and 8123 as R1, R1/√2 and R1, respectively. The third- and fifth-order images are consequently cancelled at output 8130. When MHOIR passive switching mixer 8110 delivers an equivalent formula of Equation (5), three 45° phase components LO1 8111, LO2 8112 and LO3 8113 of the reference input have components LO 45° 1575a, LO 0° 1575b and LO −45° 1575c of the 45° phase reference signal in FIG. 2, respectively. When MHOIR passive switching mixer 8110 delivers an equivalent formula of Equation (6), LO1 8111, LO2 8112 and LO3 8113 have components LO −45° 1575c, LO −90° 1575d and inversion of LO 45° 1575a (LO −135° equivalently) of the 45° phase reference signal, respectively. Output 8130 provides a mixing result with theoretically full cancellation of the third- and fifth-order images. MHOIR passive switching mixer 8110 may be preferably used in applications less sensitive to flicker noise.

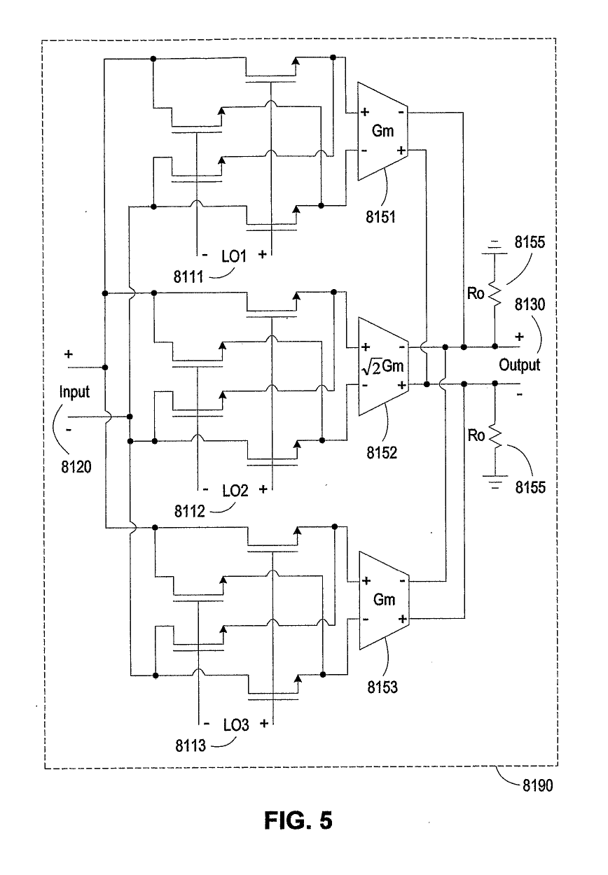

A third preferred embodiment 8190 of the MHOIR switching mixer shown in FIG. 5 is also based on passive mixers. MHOIR passive switching mixer 8190 comprises three passive mixers, which are identical here. It has a signal input 8120 and a reference (or LO) input having three 45° phase components 8111, 8112 and 8113. The outputs of the mixers are summed, by using three transconductance amplifiers 8151, 8152 and 8153, at differential loads 8155 of output 8130. The weighted summation in Equation (5) or (6) is executed by defining weights corresponding to three inputs, that is, the Gm values of transconductance amplifiers 8151, 8152 and 8153 as Gm, √2Gm and Gm, respectively. The third- and fifth-order images are consequently cancelled at output 8130. When MHOIR passive switching mixer 8190 delivers an equivalent formula of Equation (5), three 45° phase components LO1 8111, LO2 8112 and LO3 8113 of the reference input have components LO 45° 1575a, LO 0° 1575b and LO −45° 1575c of the 45° phase reference signal in FIG. 2, respectively. When MHOIR passive switching mixer 8190 delivers an equivalent formula of Equation (6), LO1 8111, LO2 8112 and LO3 8113 have components LO −45° 1575c, LO −90° 1575d and inversion of LO 45° 1575a (LO −135° equivalently) of the 45° phase reference signal, respectively. Output 8130 provides a mixing result with theoretically full cancellation of the third- and fifth-order images.

From the embodiments of MHOIR mixers of FIG. 3, FIG. 4 or FIG. 5, it can be summarized that ratios of products of the gains of the switching mixers having components LO 45° 1575a, LO 0° 1575b and LO −45° 1575c or LO −45° 1575c, LO −90° 1575d and inversion of LO 45° 1575a of the 45° phase reference signal and weights of the corresponding inputs of weighted summing means are determined as 1, √2 and 1 to satisfy the formula of Equation (5) or (6). Note that in the context, for the convenience, a set of multi-phase reference signals is equivalently represented by a multi-phase reference signal having multiple phase components. For example, a set of 45°, 0° and −45° reference signals can be represented by a three-phase reference signal of 45°, 0° and −45° components.

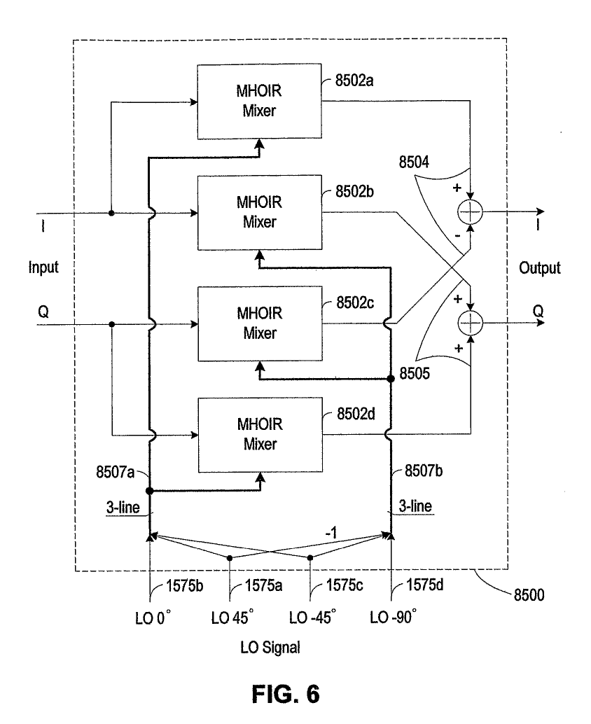

Now FIG. 6 presents a preferred embodiment of double quadrature MIR converter 8500 for zero-IF double quadrature MIR downconverter 1526 in FIG. 1. Double quadrature MIR converter 8500 comprises four identical MHOIR switching mixers 8502a-d. A multi-phase reference input 1575a-d has four phase components of 45°, 0°, −45° and −90°. Note since inversion of 45° 1575a is equivalent to −135°, converter 8500 equivalently has a multi-phase reference input of five phase components of 45°, 0°, −45°, −90° and −135°. Four MHOIR switching mixers 8502a-d may be MHOIR active switching mixer 8310 in FIG. 3, MHOIR passive switching mixer 8110 in FIG. 4 or 8190 in FIG. 5. Two MHOIR mixers 8502a and 8502c generating I signals 8504 have components LO 45° 1575a, LO 0° 1575b and LO −45° 1575c of the reference signal in FIG. 2. Two MHOIR mixers 8502b and 8502d generating Q signals 8505 have components LO −45° 1575c, LO −90° 1575d and inversion of LO 45° 1575a or LO −135° of the reference signal. The reason for that this type of MIR converter is termed as the double quadrature MIR converter is that it has the quadrature signal input and the multi-phase reference input having quadrature components of the fundamental frequency, which is similar to the terming of three quadrature converters described previously. A voltage gain up 20 dB may be assigned to zero-IF double quadrature MIR downconverter 1526 in FIG. 1.

The above three embodiments of MHOIR switching mixers 8310 in FIG. 3, 8110 in FIG. 4 and 8190 in FIG. 5 and the embodiment of double quadrature MIR converter 8500 in FIG. 6 provide illustrations how to build a MIR converter using switching mixers. It should be noted that a MIR converter can be constructed by using mixers of any type which use square-wave reference signals of multiple phase components to build a mixer module which can provide a mixing result satisfying formulas of Equations (5) and/or (6). Similarly, two other quadrature MIR converters, that is, a type-I single quadrature MIR converter and a type-II single MIR quadrature converter, can be constructed using the MHOIR switching mixers, which will be presented later.

Ideally, the third- and fifth-order images are completely cancelled in double quadrature MIR downconverter 1526. However in MHOIR mixers of FIG. 3, FIG. 4 or FIG. 5, mismatch of the switching mixers and the gain match imperfection and phase errors in all 45° phase components 8111, 8112 and 8113 of the reference signal cause an incomplete cancellation. A total rejection of the third-order image or the fifth-order image can be specified in a range of 45 to 60 dB, which includes inherent rejection of 9.5 dB for the third-order image or 14 dB for the fifth-order image (due to that third and fifth harmonics of a square-wave signal is about 9.5 dB and 14 dB, respectively, lower than the fundamental). Besides, zero-IF double quadrature MIR downconverter 1526 is required to have adequate rejection of the even-order images.

The I/Q mismatch of zero-IF double quadrature MIR downconverter 1526 can be classified as external and internal mismatches. The external I/Q mismatch defines the mismatches in both the quadrature signal in RF stage 1519 and four-phase LO signal 1575. The I/Q mismatch in four-phase LO signal 1575 is equivalently represented by mismatch in all the phase components of four-phase LO signal 1575. The external mismatch mainly impacts the (first-order) self-image rejection performance of zero-IF double quadrature MIR downconverter 1526. The internal mismatch defines the mismatch inside zero-IF double quadrature MIR downconverter 1526, which mainly influences, as explained before, the crosstalk rejection performance. As pointed before, it is relatively easy to provide enough rejection of the self-image by RF polyphase filter 1521 and downconverter 1526. Then, the (first-order) image rejection performance of zero-IF double quadrature MIR downconverter 1526 is dominated by its crosstalk rejection performance.

Design of switching mixers is critical to zero-IF double quadrature MIR downconverter 1526. Design tradeoffs are focused on optimal circuit performances in I/Q matching, reverse isolation, flicker noise, second- and third-order distortions, and DC-offset. The phase noise of four-phase reference signal 1575 may leak to the inputs of the mixers in downconverter 1526 to corrupt the desired signal in RF stage 1519, and the amount of leaking is determined by reverse isolation of the mixers. It is critical to minimize the second-order distortion since it may create a time-varying DC to baseband 1549, which is difficult to be canceled. DC-offset at the output of zero-IF downconverter 1526 needs to be minimized because it will become a source of input-referred DC-offset in next baseband 1549. The I/Q mismatch, reverse isolation, DC-offset and second-order distortion can be minimized by using an optimal circuit topology, adequately large component sizes, a careful layout technique with the highest possible degree of symmetry, and an accurate process.

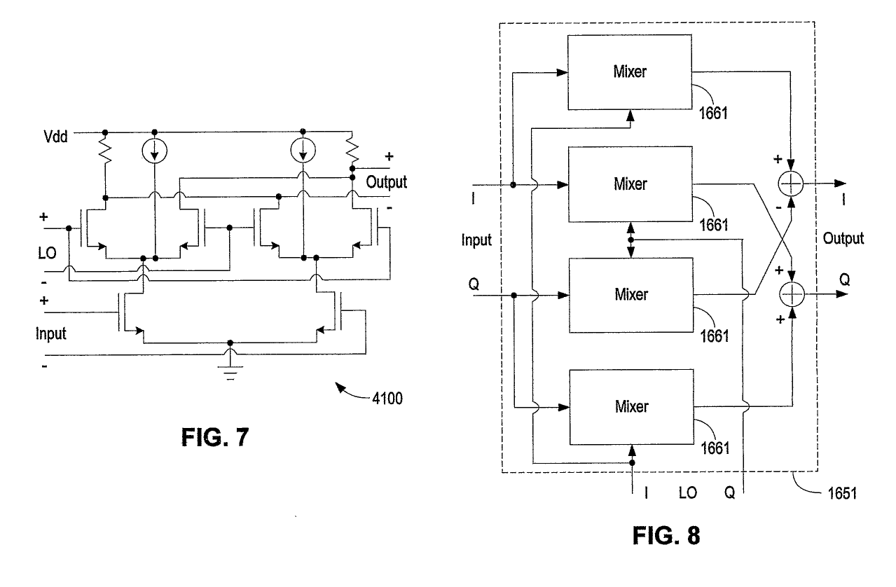

As described above, double quadrature MIR converter 8500 in FIG. 6 can be designed by using passive mixers or active switching mixers. A conventional passive mixer in the art, having a signal input, a reference input and an output, is a voltage-to-voltage frequency converter and thus has a high linearity. Normally quadrature MIR downconverter 8500 based on passive mixers is able to achieve better component match and thus higher image rejection performance. However, the passive mixer typically has reverse isolation poorer than active switching mixers, and it also possesses flicker noise which may impact zero-IF downconversion, Alternatively, active switching mixers are able to achieve high reverse isolation. An embodiment of active switching CMOS mixer 4100 in FIG. 7 which has a signal input, a reference input and an output can be used in double quadrature MIR downconverter 8500 in FIG. 6. Conceptually an active switching bipolar mixer achieves lower flicker noise than an active switching CMOS mixer. In an active switching CMOS/bipolar mixer, four bipolar transistors are located in a switching stage to minimize flicker noise and two CMOS transistors in an input stage to improve the linearity of voltage to current conversion. Prior art techniques of current boosting, degeneration in input stage, and bipolar common-base input stage may be applied for improving the linearity.

In comparison with a conventional double quadrature IR downconverter which uses switching mixers, for a zero-IF downconversion receiver, the present double quadrature MIR converter 8500 in FIG. 6 has advantages which can be better understood by following comparisons. Assume that an RF polyphase filter is able to have satisfactory rejection of the third-order and/or seventh-order images. It is known that by using the conventional zero-IF double quadrature IR downconverter, an RF bandpass filter is required to reject the fifth-order image (and the higher-order images). The offset of the fifth-order image is four-times the center frequency of a desired signal. The fifth-order image has an inherent attenuation of about 14 dB. On the other hand, by using the present zero-IF double quadrature MIR downconverter 8500 in FIG. 6 to reject the third- and fifth-order images, the RF bandpass filter is required to reject the ninth-order image (and the higher-order images). The offset of the ninth-order image is eight-times the center frequency of the desired signal. The ninth-order image has an inherent attenuation of about 19 dB. Therefore in summary, the present double quadrature MIR downconverter 8500 has an advantage over the conventional double quadrature IR downconverter by having a twice-large frequency offset and an extra 5 dB inherent rejection of the lowest odd-number high-order image an RF bandpass filter needs to suppress.

A quadrature MIR downconverter can also be designed by using a phase-shifted square-wave reference signal having components (30°, −30°), (−60°, −120°), rather than the four (or five) 45° phase components. However, this quadrature MIR downconverter rejects a third-order image but not a fifth-order image. An embodiment of this quadrature MIR downconverter is a similar but simplified version of embodiment 8500 in FIG. 6. For example, corresponding to FIG. 6, 3-line LO signals 8507a are replaced by 2-line LO signals of (30°, −30°), and 3-line LO signals 8507b are replaced by 2-line LO signals of (−60°, −120°). And also in embodiments of MHOIR switching mixers 8310 in FIG. 3, 8110 in FIG. 4 and 8190 in FIG. 5, middle-path circuit blocks corresponding to LO2 input 8112 are removed. In this example, it is summarized that ratios of products of the gains of the switching mixers and weights of the corresponding inputs of the weighted summations or summers are the same. Other embodiments of the MIR downconverter can be provided using reference signals of more phase components to possibly reject more high-order images. But the circuit complexities may increase significantly. A first such embodiment is to use two sets (30°, 0°, −30°) and (−60°, −90°, −120°) for the reference signals; ratios of products of gains of switching mixers having the 30°, 0°, −30°, −60°, −90° and −120° components and weights of the corresponding inputs of the weighted summations or summers are 1, √3, 1, 1, √3 and 1, respectively. A second such embodiment is to use two sets (60°, 30°, −30°, −60°) and (−30°, −60°, −120°, −150°) for the reference signals; ratios of products of gains of switching mixers having the 60°, 30°, −30° and −60° components or the −30°, −60°, −120° and −150° components and weights of the corresponding inputs of the weighted summations or summers are √3, 1, 1 and √3, respectively. Each of these two embodiments of the MIR downconverter rejects fifth- and seventh-order images. A third such embodiment is to use two sets (60°, 30°, 0°, −30°, −60°) and (−30°, −60°, −90°, −120°, −150°) for the reference signals; ratios of products of gains of switching mixers having the 60°, 30°, 0°, −30° and −60° components or the −30°, −60°, −90°, −120° and −150° components and weights of the corresponding inputs of the weighted summations or summers are √3, 3, 2√3, 3 and √3, respectively. This embodiment of the MIR downconverter rejects third-, fifth- and seventh-order images. The above ratios can be simply derived by formulas similar to those of Equations (1)-(6).

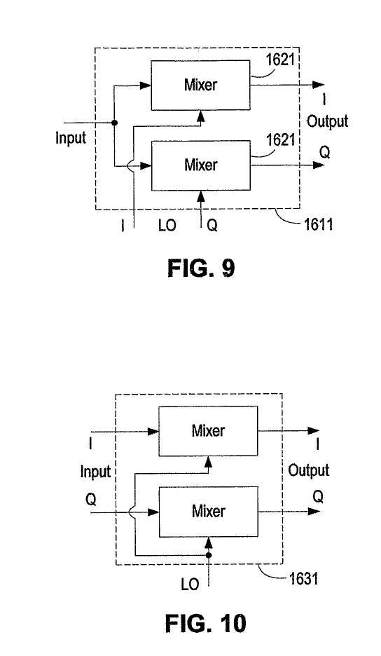

Return to zero-IF downconversion 1526 in dual-conversion tuner 1501 in FIG. 1. There are several alternatives for zero-IF downconversion 1526. An embodiment for zero-IF downconversion 1526 is a prior art double quadrature converter 1651 in FIG. 8, which rejects only the (first-order) image. LO signal 1575 is then a quadrature signal of (0°, −90°). Another embodiment for zero-IF downconversion 1526 is a prior art type-I single quadrature downconverter 1611 in FIG. 9. RF polyphase filter 1521 is then removed. And another embodiment for zero-IF downconversion 1526 is a type-II single quadrature converter 1631 in FIG. 10. LO signal 1575 is then a real signal. However, the design constraints of RF bandpass filter 1516 need to be increased for these alternatives. Optionally, a prior art downconverter as above and a MIR downconverter are jointly used for converting different subbands of channels of RF signal 1500, where the MIR downconverter may be used for the lower-frequency subbands for a better I/Q matching.

Now return to the design of RF BP filter 1516. RF BP filter 1516 is a frequency-tunable filter which approximately tracks the center frequency of RF desired signal 1500 of a selected channel. Practically, RF BP filter 1516 is a bank of switchable filters which tends to deliver even-distributed image suppressions across the entire frequency band, switched in accordance with channel tuning. These filters may be partially implemented in LNA 1511 block. In an embodiment, RF filter bank 1516 comprises a combination of RC lowpass and highpass, GmC bandpass and LC bandpass filters for switching to different subbands of RF signal 1500. Auto-tuning may or may not be needed in these low-Q filters. The design specification of RF BP filter 1516 for suppressing the high-order images depends on terrestrial and cable applications. The second- and third-order nonlinearities of RF stage 1519 may create nonlinear products into the desired signal spectrum when receiving large interference signals in RF signal 1500. The second-order nonlinearity can also result in DC and near-DC distortion products which then leak into baseband 1549 due to circuit mismatch in zero-IF downconverter 1526. Therefore, besides the careful differential circuit design and layout, RF BP filter 1516 should provide enough suppression on strong interference signals in RF signal 1500. A small voltage gain of 0 to 10 dB is assigned to RF BP filter 1516.

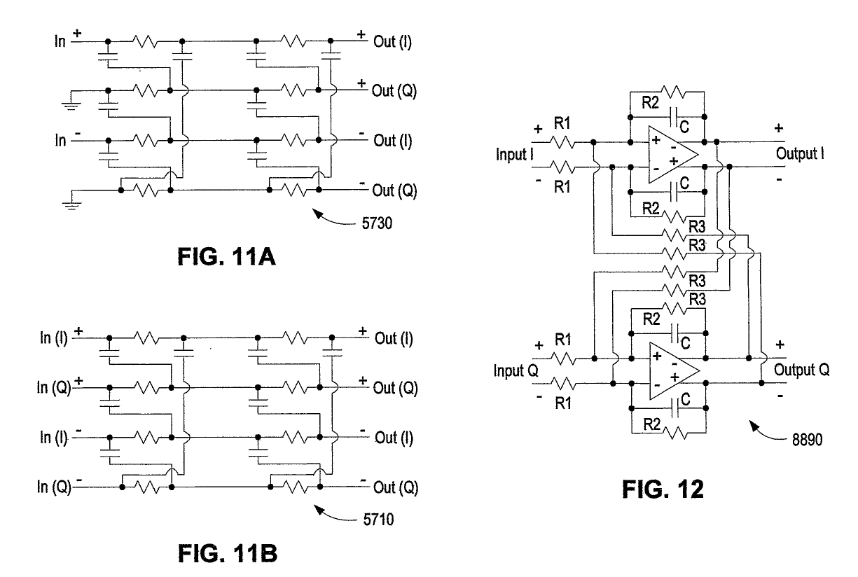

RF polyphase filter 1521 needs to provide a certain amount of suppression of the (first-order),self-image signal at RF stage 1519. RF polyphase filter 1521 then converts the real RF input signal to a quadrature RF output signal. An example of RF polyphase filter 1521 is illustrated as two-stage polyphase filter 5730 in FIG. 11A. Multi-stage RF polyphase filter 1521 optionally provide suppression of positive sidebands of the third-order or seventh-order images in order to further relax the design requirement of RF filter 1516. Actually a bank of switchable polyphase filters is designed for RF polyphase filter 1521 and respective to a predefined set of subbands covering the entire frequency band. Highly linear amplifier buffers are optionally applied to stages of polyphase filter 1521, and a total voltage gain of −3 to 10 dB is assigned to RF polyphase filter 1521.

Design specifications of RF BP filter 1516 and polyphase filter 1521 need to be jointly considered. A design example is discussed below for specifications of 40 dB rejection of the (first-order) image and 80 dB rejection of the high-order images. Zero-IF MIR downconverter 1526 is specified to provide 50 dB rejection for the third- and fifth-order images. RF BP filter 1516 is specified to provide 61 dB rejection of the ninth-order image and small rejection of 30 dB of the third-order image. RF polyphase filter 1521 may be then specified to provide about 20 dB rejection on the (first-order) image and the positive sideband of the seventh-order image, based on a frequency response of RF BP filter 1516. After filtering by two filters 1516 and 1521, the desired RF signal in RF stage 1519 is downconverted by zero-IF MIR downconverter 1526 to baseband 1549.

The use of zero-IF 1549 as the middle IF stage finds a way to distribute a large, programmable gain next to output IF stage 1559. As a result, baseband circuitry 1549 may, at minimum, provide a limited voltage gain of 20 dB for the purpose of maximizing the noise performance. Baseband circuitry 1549 is required to minimize the input-referred DC-offset by using careful design and layout. The output DC-offset of baseband stage 1549 is then roughly ten times of the total input-referred DC-offset, which represents both the input-referred DC-offset of baseband LP filter 1536 and the output DC-offset of downconverter 1526. This maximum amount of output DC-offset normally has negligible influence on linear operation of the circuitry in baseband 1549. Prior art DC-offset compensation methods may be used in baseband 1549, especially for digital modulation systems where the DC removal is less sensitive. These methods include uses of highpass filters, feedback loops, and hybrid analog/digital solutions. In addition, a common-mode (CM) feedback network may be used in LP filter 1536 to adequately control the output CM level.

In baseband 1549, the mismatch in the I and Q paths causes a frequency crosstalk between the positive and negative sidebands of the desired signal. The crosstalk causes superposition of a suppressed mirror signal on the desired signal. Since baseband circuitry 1549 operates in low frequency, it tends to achieve a better I/Q matching performance. For a target rejection specification of the (first-order) image in zero-IF downconverter 1526, baseband circuitry 1549 is preferable to provide a crosstalk rejection of 5 to 10 dB better than the specification, which determines the I/Q match specification of baseband 1549. Prior art I/Q mismatch compensation methods may be used in baseband 1549 if necessary. Among these methods are gain mismatch compensation, phase error compensation, and joint gain mismatch and phase error compensation.

At minimum, LP filter 1536 in baseband 1549 is defined only to provide anti-aliasing filtering for final upconversion 1546. The use of double quadrature upconverter 1546 can relax the design requirement of LP filter 1536. Alternatively, LP filter 1536 can be defined to provide channel selectivity and suppression of interference signals in accordance with system specifications of applications. It can be seen that dual-conversion tuner architecture 1501 provides an opportunity of circuit design tradeoff by allocating major IF filtering tasks of channel selectivity and interference suppression to LP filter 1536 in baseband 1549. Consequently a lower-quality output IF bandpass filter 1556 may be designed only to filter out the high-order mixing products from upconverter 1546, in accordance with the sampling frequency of an analog-to-digital (A/D) converter. Note that a first-order RC lowpass filter may be included in the load of downconverter 1526 to attenuate strong non-adjacent interference signals.

Baseband PGA 1541 is optionally assigned in baseband 1549 for AGC functionality. PGA 1541 may be used to fully or partially execute the AGC function for delivering an optimal desired signal level at IF output port 1599, or it may be bypassed. PGA 1541 may be implemented in the stages of LP filter 1536, completely or partially. The gain control range is from 0 to 60 dB with a control step of 1, 2, or more dB.

Upconverter 1546 upconverts baseband desired signal 1549 to output IF 1559. FIG. 8 shows an embodiment 1651 of double quadrature upconverter 1546. Quadrature reference signal 1585 for upconverter 1546 has its frequency equal to the frequency of output IF 1559. For the same reason, upconverter 1546 is designed to minimize I/Q mismatch by using the large device matching technique. If the spectrum of the desired signal needs to be inverted in upconverter 1546, baseband desired signal 1549 is upconverted to output IF 1559 where the negative sideband is defined as the wanted sideband. In upconversion 1546, an embodiment of type-II single quadrature converter 1631 in FIG. 10 may be used but it will increase the design constraint of baseband LP filter 1536. Alternatively, double quadrature MIR converter 8500 in FIG, 6 may be used in upconversion 1546 to relax the design constraint of LP filter 1536, particularly for the frequency of output IF 1559 defined in a relatively low frequency range.

Output IF polyphase filter 1551 is optionally used to suppress, by about 40 dB, the main sideband of the third-order mixing product in switching upconverter 1546. The use of polyphase filter 1551 can relax the design constraint of the next IF bandpass filter 1556, particularly for a real bandpass filter design. An embodiment of output IF polyphase filter 1551 is shown in FIG. 11B as a two-stage polyphase filter 5710.

Output IF BP filter 1556 may be designed only to attenuate the high-order mixing products in switching upconverter 1546 according to the IF interface specifications and the sampling frequency of the A/D converter, when baseband LP filter 1536 provides the channel selectivity and interference suppression (as described previously). Consequently, the issues in frequency response, dynamic range, component spread, and group delay can be reduced in output IF BP filter 1556. Alternatively, output IF BP filter 1556 is designed to provide the final channel selectivity and interference suppression, and it may act as an anti-aliasing filter for the A/D converter or provide additional filtering, like Nyquist slope attenuation characteristic filtering. Frequency response of output IF BP filter 1556 is defined based on system specifications of applications. If an active complex bandpass filter is designed for output IF BP filter 1556, polyphase filter 1551 may be bypassed (that is, removed). If a real bandpass filter is designed for output IF BP filter 1556, polyphase filter 1551 is preferably used. It is possible to design low-quality OpAmp-based BP filter 1556 even when output IF 1559 frequency is relatively high. Auto-tuning may not be needed then. An embodiment of OpAmp-based complex bandpass filter 1556 is a cascade of complex filter stages 8890 in FIG. 12. Or a Gm-based complex or real bandpass filter may be designed for output IF BP filter 1556, especially when the frequency of output IF 1559 is high.

A group-delay equalizer (not shown) may be employed in output IF stage 1559 and optionally between output IF polyphase filter 1551 and output IF BP filter 1556 to compensate nonlinear phase distortion occurring in output IF stage 1559.

A receive signal strength indicator (RSSI) circuitry (not shown) may be implemented at the output of output IF BP filter 1556 to indicate the desired signal level. A RSSI signal may be requested to send to a demodulator.

The PGA in PGA/Driver block 1558 is used for the AGC functionality When needed, it incorporates with baseband PGA 1541 to deliver an optimal signal level at IF output port 1599. External AGC signal 1560, a multi-bit signal, is provided by a demodulator and via a serial data interface. The AGC stages in PGA/Driver block 1558 can be embedded in stages of output IF BP filter 1556. The gain control range may be from 0 to 60 dB with a control step of 1, 2, or more dB.

The output driver cascaded to the PGA in PGA/Driver block 1558 is designed to provide satisfactory output current, low output impedance, and programmable maximum differential and common-mode voltages at IF output port 1599.

Next describe four-phase LO signal generator 1571, quadrature LO signal generator 1581 and crystal oscillator 1580 in integrated tuner 1501 in FIG. 1.

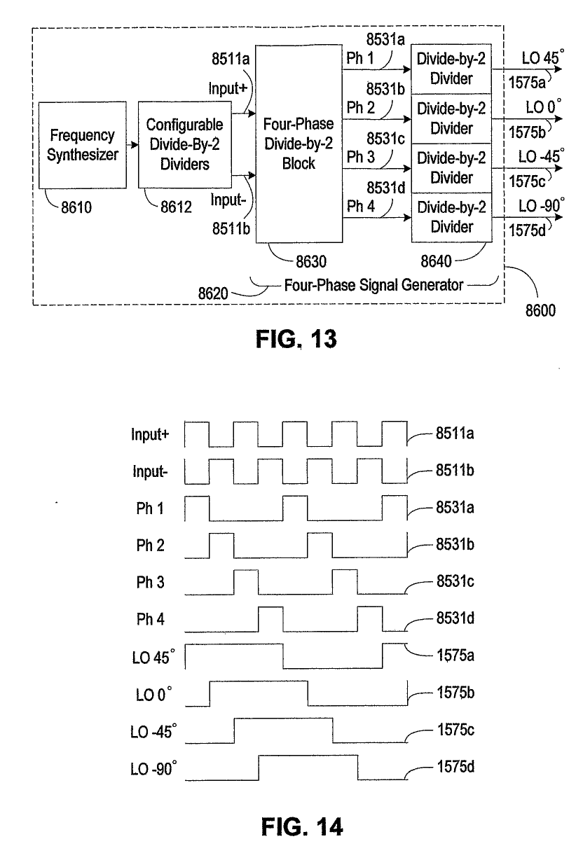

FIG. 13 illustrates an exemplary embodiment 8600 of four-phase LO signal generator 1571 in integrated tuner 1501 of FIG. 1, which provides four-phase LO signal 1575 of square-wave form. Frequency synthesizer 8610 is a tunable frequency synthesizer and outputs a tunable frequency to configurable divide-by-2 dividers 8612. Dividers 8612 provide differential Input+ 8511a, Input− 8511b to a next exemplary four-phase signal generator 8620. Generator 8620 requires a frequency of differential Input+8511a, Input− 8511b four-times the fundamental frequency of an output four-phase LO signal of components 1575a-d. Generator 8620 consists of four-phase divide-by-2 block 8630 and four identical divide-by-2 dividers 8640. It takes Input+ 8511a and Input− 8511b, as shown in FIG. 14, and generates four-phase output signals of Ph1 8531a, Ph2 8531b, Ph3 8531c and Ph4 8531d, as shown in FIG. 14. Four identical divide-by-2 dividers 8640 divide these signals 8531a-d and generate a 50% duty-cycle output reference signal of components of LO 45° 1575a, LO 0° 1575b, LO −45° 1575c, and LO −90° 1575d, as illustrated in FIG. 14.

A Sigma-Delta (SD) fractional-N frequency synthesizer may be used in synthesizer 8610 in FIG. 13. It possesses advantages of higher frequency resolution, fewer spurious and lower phase noise over an integer-N frequency synthesizer.

In order to avoid re-radiation of a tunable VCO frequency in synthesizer 8610 in FIG. 13 into the frequency band of RF input signal 1500 in FIG. 1, the VCO frequency may be designed to be above the frequency band. The VCO frequency in SD fractional-N frequency synthesizer 8610 is locked at 2^{N} times the fundamental of the output four-phase LO signal of components 1575a-d so that the VCO frequency is above the frequency band. The VCO frequency is next divided by (N_{V}=N−N_{Q}) divide-by-2 dividers in configurable divide-by-2 dividers 8612 to produce the frequency of Input+ 8511a, Input− 8511b to four-phase signal generator 8620, where N≧N_{Q}, and N_{Q}=2 corresponding to four-phase signal generator 8620 using the frequency of Input+ 8511a, Input− 8511b four-times the (fundamental) frequency of the four-phase LO signal of components 1575a-d. N is predefined for each channel and is relative to the designed frequency range of the VCO, for example, a range of 1 to 4 GHz. The VCO in synthesizer 8610 is a conventional LC VCO using a switchable capacitor bank to provide a wide-range tuning. In the digital systems, the phase noise of VCO should be low enough to prevent digital demodulation from symbol jitters and to minimize smearing of constellation. An exemplary phase noise specification of VCO is expected as: −85˜−95 dBc/Hz at 10 kHz, −90˜−100 dBc/Hz at 20 kHz, −105˜−120 dBc/Hz at 100 kHz, and −120˜−140 dBc/Hz at 1 MHz, where, dBc indicates dB relative to the power level at the center frequency.

Reference-source frequency 1570 in integrated tuner 1501 of FIG. 1 comes from crystal oscillator 1580. When the AFC function is employed, typically crystal oscillator 1580 is an external voltage-controlled oscillator (VCXO), and its frequency can be finely adjusted by external AFC signal 1590.

Quadrature LO signal generator 1581 provides quadrature reference signal 1585. It is optimal to directly use reference-source frequency 1570 or a filtered one of its harmonics from crystal oscillator 1580 in FIG. 1 as a real reference source in quadrature LO signal generator 1581, which depends on flexibility in selecting the frequency of crystal oscillator 1580. Then dividers may be used to first divide down reference-source frequency 1570. These dividers may be a combination of divide-by-2, divide-by-3, divide-by-5, divide-by-7, etc. dividers. A polyphase filter 5730 shown in FIG. 11A or a prior art four-phase divide-by-2 divider can be used to generate quadrature reference signal 1585.

The frequency of output IF 1559 may be made to be tunable by using a tunable quadrature LO signal generator 1581. Tunable IF bandpass filter 1556 (and IF polyphase filter 1551) is designed by using various techniques known in the art. Tunable output IF 1559 frequency and IF bandpass filter 1556 may be configured by a demodulator.

In the following embodiments of integrated tuners, the blocks corresponding to the blocks in FIG. 1 are indicted with the same reference numerals, and they are substantially the same in function. Therefore these previously described blocks will not be described again. Also in the following, the block of a same reference numeral occurring in an embodiment will not be described again in later embodiments.

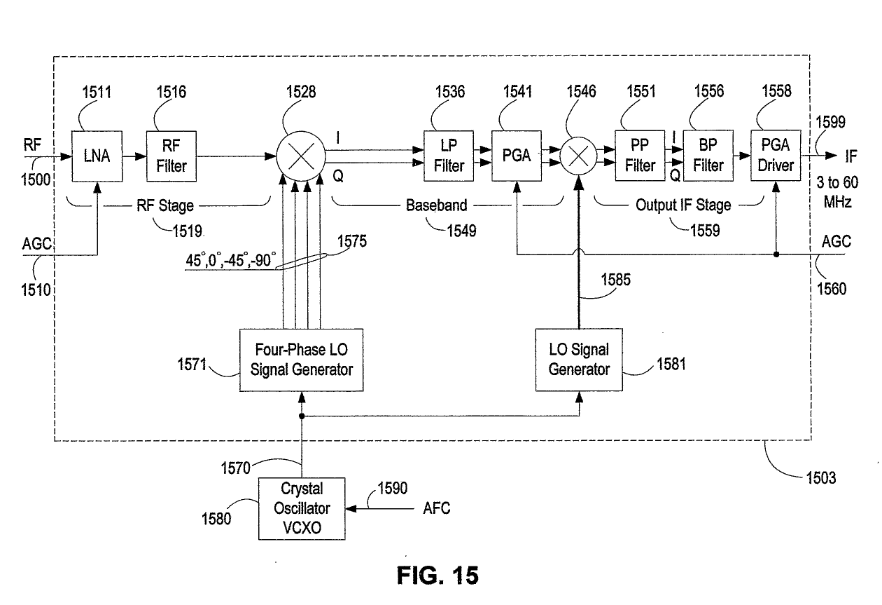

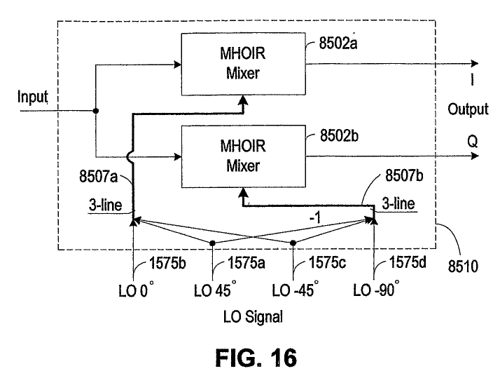

FIG. 15 presents another preferred embodiment of an integrated tuner of dual-conversion architecture 1503 in accordance with the present invention. A type-I single quadrature MIR downconverter is used in zero-IF downconversion 1528. FIG. 16 shows an embodiment 8510 of the type-I single quadrature MIR downconverter 1528. This MIR downconverter is hereby termed as the type-I single quadrature MIR downconverter, because it has a real signal input and a multi-phase reference input having the quadrature components of the fundamental frequency. Two MHOIR switching mixers 8502a-b in FIG. 16 may be MHOIR active switching mixer 8310 in FIG. 3, MHOIR passive mixer 8110 in FIG. 4 or MHOIR passive mixer 8190 in FIG. 5. Zero-IF type-I single quadrature MIR downconverter 1528 has the real signal input directly coupled to RF BP filter 1516. Without a polyphase filter in RF stage 1519 to suppress the (first-order) self-image, this simplified dual-conversion tuner 1503 tends to have the (first-order) image rejection lower than dual-conversion tuner 1501 in FIG. 1. However, dual-conversion tuner 1503 possesses useful advantages for some applications: potentially achieving larger dynamic range, lower power consumption and lower complexity.

Another preferred embodiment of an integrated tuner of dual-conversion architecture in accordance with the present invention is derived from dual-conversion tuner 1501 in FIG. 1 by replacing zero-IF double quadrature MIR downconverter 1526 with a zero-IF type-II single quadrature MIR downconverter, which has a quadrature signal input and a multi-phase reference input of only three components of 45°, 0° and −45°. An embodiment of the type-II single quadrature MIR converter can be obtained from simplifying double quadrature MIR converter 8500 in FIG. 6 by only using MHOIR mixers 8502a and 8502d and reference signals of LO 45° 1575a, LO 0° 1575b and LO −45° 1575c. This MIR converter is hereby termed as the type-II single quadrature MIR downconverter, because it has the quadrature signal input and the multi-phase reference input having only the real component of the fundamental frequency. Since the multi-phase reference input has a similar role as a real reference signal, this simplified dual-conversion tuner tends to have the (first-order) image rejection lower than dual-conversion tuner 1501 in FIG. 1 but it may have some applications requiring lower (first-order) image rejection.

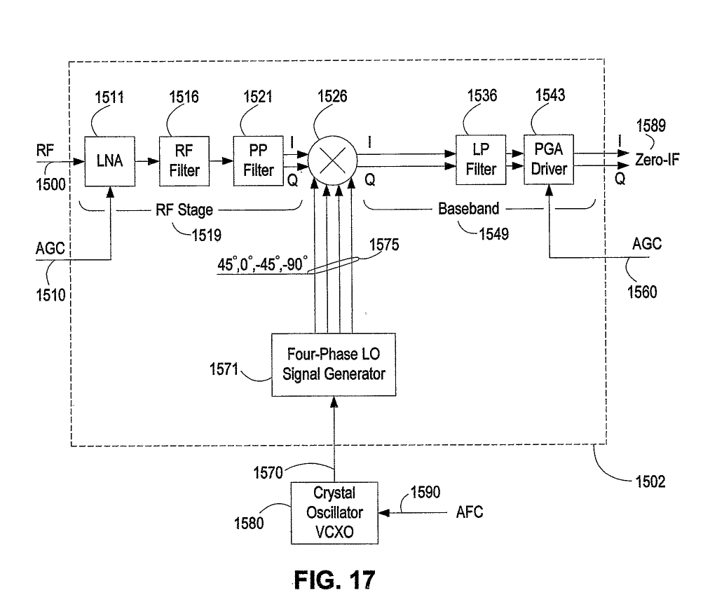

FIG. 17 presents a preferred embodiment of an integrated tuner of zero-IF direct-downconversion architecture 1502 in accordance with the present invention. In FIG. 17, the RF desired signal in RF stage 1519 is directly downconverted by zero-IF double quadrature MIR downconverter 1526 to baseband 1549 (zero-IF). FIG. 6 shows an embodiment 8500 of double quadrature MIR downconverter 1526. Zero-IF direct-downconversion tuner 1502 can interface with a demodulator having a baseband input interface. Baseband lowpass filter 1536 is defined to provide channel selectivity and suppression of interferences. It also acts as an anti-aliasing filter for A/D converters of a digital demodulator. A group-delay equalizer and a RSSI circuitry may be implemented next to baseband LP filter 1536. A PGA in PGA/Driver block 1543 provides AGC functionality for delivering an optimal desired signal level at zero-IF output port 1589. An output driver in PGA/Driver block 1543 next provides satisfactory output current and low output impedance to output port 1589. The prior art I/Q mismatch and DC-offset compensation methods may be used in baseband 1549, especially for digital demodulations.

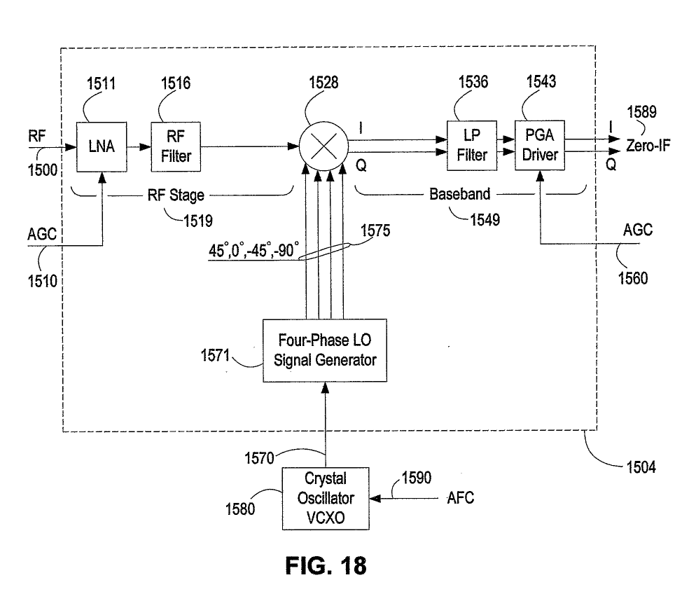

FIG. 18 presents another preferred embodiment of an integrated tuner of zero-IF direct-downconversion architecture 1504 in accordance with the present invention. A type-I single quadrature MIR downconverter is used in zero-IF downconversion 1528. FIG. 16 shows an embodiment 8510 of type-I single quadrature MIR downconverter 1528. The zero-IF type-I single quadrature MIR downconverter 1528 has a real signal input directly coupled to RF BP filter 1516. The desired signal in RF stage 1519 is filtered by RF BP filter 1516 and then downconverted by zero-IF type-I single quadrature MIR downconverter 1528 to baseband 1549.

Another preferred embodiment of an integrated tuner of zero-IF direct-downconversion architecture in accordance with the present invention is derived from zero-IF direct downconversion tuner 1502 in FIG. 17 by replacing zero-IF double quadrature MIR downconverter 1526 with a type-II single quadrature MIR downconverter, described previously. This simplified zero-IF direct downconversion tuner and zero-IF direct downconversion tuner 1504 in FIG. 18 tend to have the (first-order) image rejection lower than zero-IF direct downconversion tuner 1502 in FIG. 17. However, these embodiments have achievable advantages of larger dynamic range, lower power consumption and lower complexity for many applications.

Zero-IF direct downconversion tuners 1502 in FIG. 17 and 1504 in FIG. 18 and the embodiment above may fit well into digital terrestrial TV applications, like DVB-T, DVB-H, ATSC, etc. In these standards, the relatively low C/N ratio thresholds relax the I/Q match requirements in downconverter 1526 or 1528 and baseband circuitry 1549. Also proper removal of DC and near-DC frequency components in the desired signal of baseband 1549 can make minimal impact on the BER performance in digital demodulators.

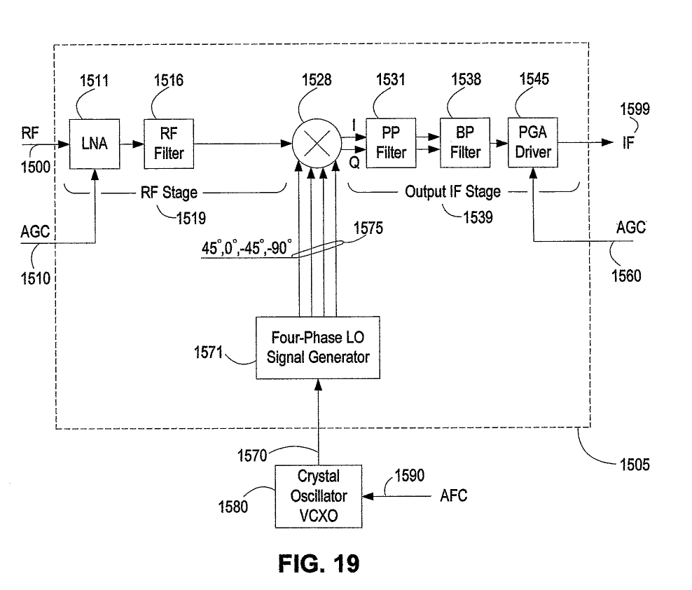

FIG. 19 presents a preferred embodiment of an integrated tuner of low-IF single-conversion architecture 1505 in accordance with the present invention. The desired signal in RF stage 1519 is directly downconverted by a low-IF double quadrature MIR downconverter 1528 to a low-frequency output IF 1539. Low-IF single-conversion tuner 1505 can interface with a demodulator able to provide this low-IF input interface. The center frequency of low-frequency output IF 1539 is preferably defined to be equal to or slightly greater than one half of a channel spacing of RF signal 1500. Consequently, the (first-order) image of this low-IF single-conversion tuner 1505 is substantially caused by a lower or higher adjacent channel.

The rationale of defining such a low frequency of output IF 1539 is that the Carrier-to-Interference (C/I) ratios of two adjacent channels are normally higher or much higher than those of other non-adjacent channels in most TV systems. The Low-IF downconversion has advantages in coping with circuit issues which are well known in a zero-IF downconversion, like DC-offset and flicker noise (in a CMOS implementation). This low-IF single downconversion tuner 1505 can be used in any systems where, based on the specified C/I ratios of adjacent channels, the (first-order) image rejection performance of tuner 1505 can result in a negligible image power at output IF 1539, for instance, 10 to 15 dB lower than the noise floor at output IF 1539 when the C/N ratio at output IF 1539 approaches a specified C/N ratio threshold. The center frequency of low-frequency output IF 1539 may possibly be defined up to one of the channel spacing.

LNA 1511 amplifies RF signal 1500, and RF BP filter 1516 suppresses high-order images in low-IF downconversion 1528 and other strong interference signals. The desired signal in RF stage 1519 is then downconverted by low-IF type-I quadrature MIR downconverter 1528 to output IF 1539. Low-IF type-I quadrature MIR downconverter 1528 is a single sideband downconverter, with a high-side or low-side LO injection. A first-order RC lowpass filter may be included in its load to attenuate strong non-adjacent interference signals. After downconversion 1528, IF polyphase filter 1531 is used to suppress an IF image. The IF image is from downconversion of a sideband of the image signal which is twice the output IF frequency away from the wanted sideband of RF desired signal 1500. Next, IF BP filter 1538 may provide additional IF image suppression and provides channel selectivity and suppression of interferences. It also acts as an anti-aliasing filter for an A/D converter. A group-delay equalizer may be implemented between IF polyphase filter 1531 and IF BP filter 1538. A RSSI circuitry may be implemented next to IF BP filter 1538. A PGA in PGA/Driver block 1545 performs AGC functionality, controlled by AGC signal 1560. Finally, a driver in PGA/Driver block 1545 is configured to provide a satisfactory interface for the A/D converter.

FIG. 16 shows a first embodiment 8510 of low-IF type-I quadrature MIR downconverter 1528, where two MHOIR switching mixers 8502a and 8502b may be MHOIR active switching mixer 8310 in FIG. 3, MHOIR passive switching mixer 8110 in FIG. 4, or MHOIR passive switching mixer 8190 in FIG. 5.

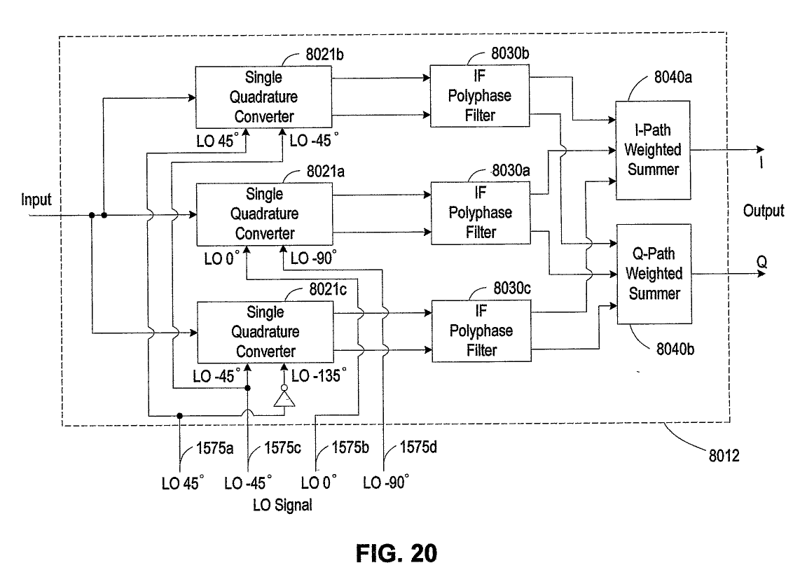

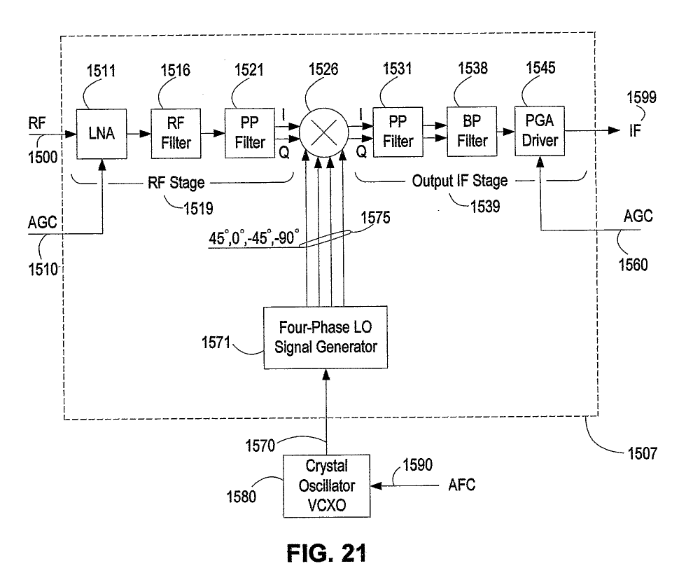

FIG. 20 presents a second embodiment 8012 of low-IF type-I single quadrature MIR downconverter 1528. A higher priority in this embodiment is given to the circuit performance of the IF image suppression, because after the downconversion, the IF image is immediately suppressed by IF polyphase filters. Embodiment 8012 has three stages. In the first stage, there are three type-I single quadrature converters 8021a-c having the same real (differential) input signal. Each of them has a pair of quadrature reference signal: quadrature LO 0° 1575b and LO −90° 1575d (the waveforms shown in FIG. 2) for converter 8021a, quadrature LO 45° 1575a and LO −45° 1575c for converter 8021b, and quadrature LO −45° 1575c and inversion of LO 45° 1575a (or LO −135°) for converter 8021c. In the second stage, there are three identical IF polyphase filters 8030a-c for the IF image suppression. In the final stage, there are two identical weighted summers 8040a-b in the I and Q paths for implementing the weighted summations in Equations (5) and (6).

In FIG. 20, type-I single quadrature converters 8021a-c may be implemented by using passive mixers or active switching mixers. An embodiment 1611 of type-I single quadrature converter is shown in FIG. 9, where mixer 1621 is either an active switching mixer or a passive mixer.

Three IF polyphase filters 8030a-c in the second stage of FIG. 20 are designed to suppress the IF image. A sideband of the image signal at RF input 1500 in FIG. 19 is downconverted to output IF stage 1539 as the IF image signal mirroring to the wanted sideband of the IF desired signal. The mismatch in any IF quadrature path in FIG. 20 causes a frequency crosstalk between the positive and negative sidebands. Hence IF polyphase filters 8030a-c are utilized to suppress this IF image in its first place in each of the three IF quadrature paths. FIG. 11B shows an embodiment of a two-stage polyphase filter 5710. IF polyphase filter 8030a-c should provide enough suppression of the IF image so that all the mismatches in next weighted summers 8040a-b will have a negligible influence on the IF image rejection performance. The quadrature matching requirement may be around 0.3% for the design of IF polyphase filters 8030a-c to minimize the crosstalk inside the filters. If IF polyphase filters 8030a-c are designed to provide a satisfactory suppression of the IF image, the output quadrature signals of IF polyphase filters 8030a-c may be merged to real signals. Then one summer 8040a or 8040b is needed, and IF polyphase filter 1531 in FIG. 19 can be bypassed. Otherwise, the IF image rejection task can be distributed between IF polyphase filters 8030a-c and IF polyphase filter 1531 in FIG. 19.

Two identical weighted summers 8040a-b in the final stage of FIG. 20 conduct the formulas of Equations (5) and (6), respectively. The weighted summers can be implemented using OpAmps or Gm amplifiers. An embodiment of the OpAmp-based weighted summer is the same as OpAmp (8125) based summer in FIG. 4; an embodiment of the Gm-based weighted summer is the same as the summer (8151-8153) in FIG. 5.

Now returning to FIG. 19, IF polyphase filter 1531 is conventionally designed to have enough suppression in output IF stage 1539. For the IF image rejection of around 50 dB, the I/Q matching requirement of IF polyphase filter 1531 is specified as around 0.3%.

The first exemplar of defining IF polyphase filter 1531 and IF bandpass filter 1538 is more like a conventional solution. IF polyphase filter 1531 provides a satisfied suppression of the IF image and then converts the quadrature differential IF signal to a real differential IF signal (this operation occurs inside IF BP filter 1538). IF BP filter 1538 is then a real signal filter and is defined to provide channel selectivity and suppression of interferences. It also acts as an anti-aliasing filter for an A/D converter or may provide additional filtering for some applications. OpAmp-based BP filter 1538 is normally designed as a cascade of filter stages and may need prior art auto-tuning. A gain of 10 to 40 dB is distributed among the stages of IF BP filter 1538.

The second exemplar of defining IF polyphase filter 1531 and IF bandpass filter 1538 is a solution presented by this invention. A two- to four-stage IF polyphase filter 1531 is designed to provide an exemplary suppression of 30 to 40 dB of the IF image. An active complex bandpass filter is defined for IF BP filter 1538. Due to the IF image suppression by IF polyphase filter 1531, the I/Q matching specification of IF active complex bandpass filter 1538 can be relaxed significantly. IF complex bandpass filter 1538 can be designed to provide an additional suppression of the IF image for a total IF image rejection requirement. Active complex IF bandpass filter 1538 is designed based on operational or Gm amplifiers. An embodiment of complex bandpass filter 1538 is a multi-stage complex bandpass filter. FIG. 12 shows one stage 8890 of a multi-stage OpAmp-based complex bandpass filter 1538. The quadrature differential output signal of complex bandpass filter 1538 is then converted into a single differential output signal. Note that IF polyphase filter 1531 may be removed and only active complex IF bandpass filter 1538 is designed to meet the requirements of IF image rejection and IF signal filtering.

Additionally, a group-delay equalizer (not shown) may be employed somewhere in output IF stage 1539 in FIG. 19 to compensate any nonlinear phase distortion caused by the filters in output IF stage 1539. A RSSI circuitry (not shown) may be implemented at the output of BP filter 1538 to indicate the desired signal level.

The PGA in PGA/Driver block 1545 is used for AGC functionality and controlled by external AGC signal 1560, which may be embedded in IF bandpass filter 1538. The gain control range may be from 30 to 60 dB with control step of 1, 2, or more dB. The driver in PGA/Driver block 1545 is designed to provide satisfactory output current and low output impedance to IF output port 1599.

Four-phase LO signal generator 1571 is almost the same as four-phase LO signal generator 1571 in FIG. 1, except that four-phase LO signal generator 1571 in FIG. 19 is programmed for low-IF downconversion 1528. Mainly due to the I/Q match imperfection of four-phase LO signal 1575, a sideband of the (first-order) image at RF input 1500, which is twice the frequency of output IF 1539 away from the unwanted sideband of the desired signal, is downconverted to output IF stage 1539 with a suppression. As a consequence, this suppressed image (sideband) is superimposed on the desired signal in output IF stage 1539. A total I/Q mismatch specification in a range of 1% to 2% of four-phase LO signal 1I575 may be defined, depending on specifications of applications.

FIG. 21 presents another preferred embodiment of an integrated tuner of low-IF single-conversion architecture 1507 in accordance with the present invention. The desired signal in RF stage 1519 is first filtered by RF BP filter 1516 and RF polyphase filter 1521 and then directly downconverted by a low-IF double quadrature MIR downconverter 1526 to a low-frequency output IF 1539. RF polyphase filter 1521 is provided to attenuate the sideband of the (first-order) image at RF input 1500, which is twice the frequency of output IF 1539 away from the unwanted sideband of the desired signal of RF input 1500. FIG. 6 provides a first embodiment 8500 of low-IF double quadrature MIR downconverter 1526. A second embodiment of double quadrature MIR downconverter 1526 can be directly derived from the second embodiment of 8012 of the type-I single quadrature MIR downconverter in FIG. 20 simply by replacing three type-I single quadrature converters 8021 a-c with three double quadrature converters of embodiment 1651 in FIG. 8. Low-IF single-conversion tuner 1507 is able to provide a stronger rejection of the (first-order) image than low-IF single-conversion tuner 1505 in FIG. 19 but costs more in the circuit complexity.

It should be noted that the preferred embodiment of 8012 of the type-I single quadrature MIR downconverter in FIG. 20 and the double quadrature MIR downconverter above derived from FIG. 20 can be directly used for other quadrature MIR downconverters, for example, having the phase-shifted reference signal of (30°, 0°, −30°) and (−60°, −90°, −120°), rather than four 45° phase components, and the phase-shifted reference signal of (30°, −30°), (−60°, −120°), where only two quadrature converters and polyphase filters are needed. Also, an embodiment of type-II single quadrature MIR downconverter can be derived from embodiment 8012 of the type-I single quadrature MIR downconverter in FIG. 20 by replacing type-I single quadrature converters with type-II single quadrature converters and using components LO 45° 1575a, LO 0° 1575b and LO −45° 1575c of the reference signal.

Another preferred embodiment of an integrated tuner of low-IF single-conversion architecture in accordance with the present invention is derived from low-IF single-conversion tuner 1507 in FIG. 21 by replacing low-IF double quadrature MIR downconverter 1526 with a type-II single quadrature MIR downconverter previously described.

For the low-IF single-conversion tuners above, one interesting application is the ISDB-T One-Segment mobile service. The frequency of output IF 1539 can be defined between one half of the segment bandwidth (430/2 kHz) and one-forth of the channel bandwidth (6/4 MHz), like 500 kHz. The image is then located within a selected TV channel of 6 MHz, thus its power is much smaller than that in other low-IF single-conversion receivers, even considering a high peak-to-average power ratio of COFDM.

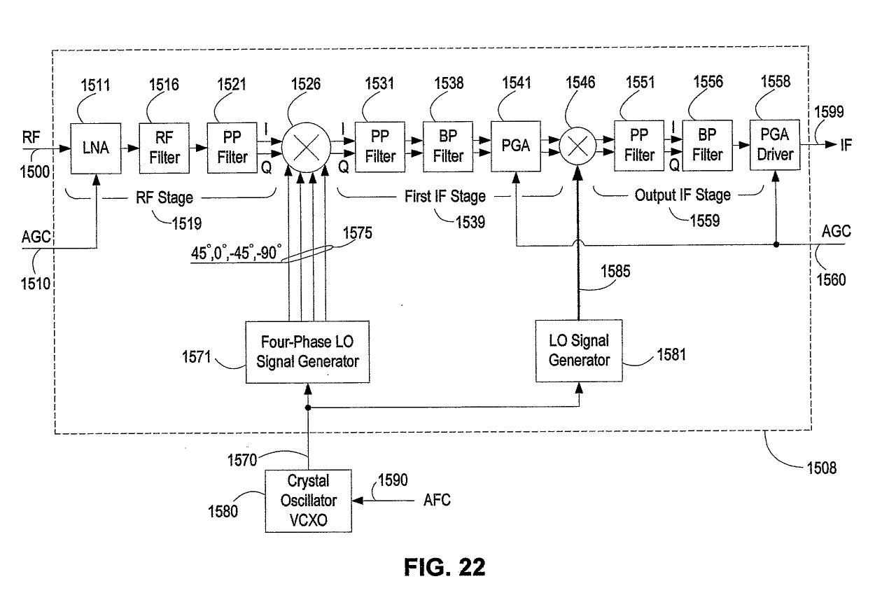

FIG. 22 presents a preferred embodiment of an integrated tuner of dual-conversion architecture 1508 in accordance with the present invention. All the circuit blocks in FIG. 22 have been described before. The center frequency of first IF 1539 can be defined to be equal to or slightly greater than one half of a channel spacing of RF signal 1500, up to one of the channel spacing. The center frequency of output IF 1559 is defined to be higher than the center frequency of first IF 1539, up to 60 MHz if needed, to meet an IF interface frequency requirement, like 44 MHz or 36 MHz.

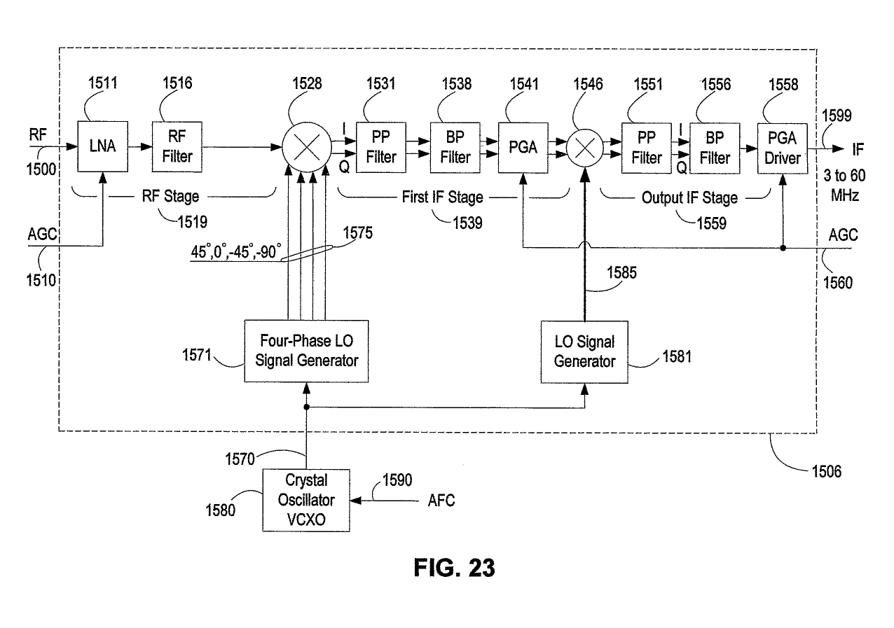

FIG. 23 presents another preferred embodiment of an integrated tuner of dual-conversion architecture 1506 in accordance with the present invention. Low-IF type-I single quadrature MIR downconverter 1528 has a real signal input directly coupled to RF BP filter 1516. Therefore, dual-conversion tuner 1506 has a lower performance of the (first-order) image rejection than dual-conversion tuner 1508 in FIG. 22 but it has a lower complexity.

Another preferred embodiment of an integrated tuner of dual-conversion architecture in accordance with the present invention is derived from dual-conversion tuner 1508 in FIG. 22 by replacing low-IF double quadrature MIR downconverter 1526 with a low-IF type-II single quadrature MIR downconverter previously described.

Note that the type-II single quadrature MIR downconverter in the embodiment above, type-I single quadrature MIR downconverter 1528 in dual-conversion tuner 1506 in FIG. 23 and double quadrature MIR downconverter 1526 in dual-conversion tuner 1508 in FIG. 22 may be replaced by a type-II single quadrature converter, a type-I single quadrature converter and a double quadrature converter of prior art, respectively, for some applications of having lower rejection requirements on the high-order images.

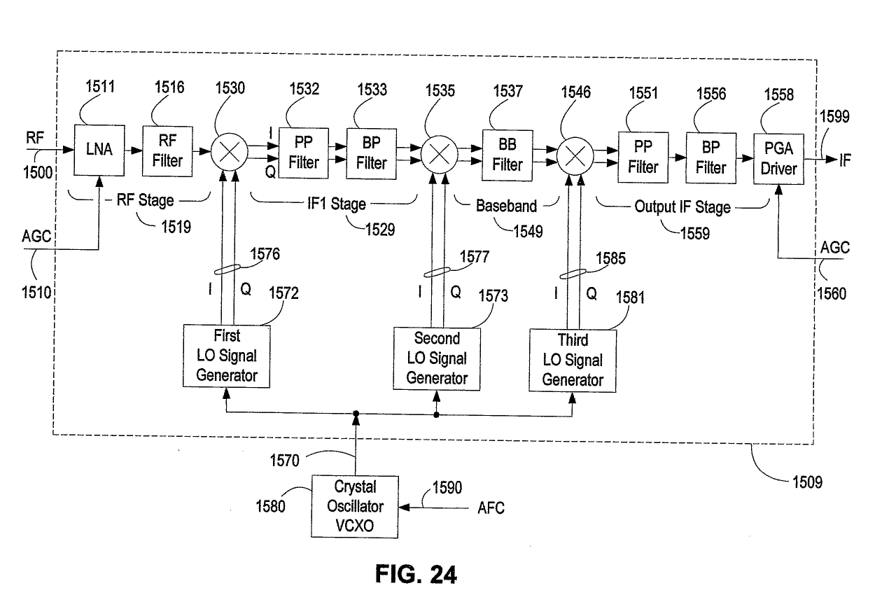

FIG. 24 presents a preferred embodiment of an integrated tuner of triple-conversion architecture 1509 in accordance with the present invention. After LNA 1511 amplifies an input RF signal 1500, RF BP filter 1516 suppresses an image in first-stage conversion 1530 and some interference signals. First-stage conversion 1530 converts the desired signal of a selected channel in RF signal 1500 to a first high-frequency IF (IF1) 1529. The center frequency of IF1 1529 is preferably defined higher than the upper bound of the frequency band, for example, 1 GHz or higher. Conversion 1530 in general relaxes the design of RF BP filter 1516 by having a large image frequency offset. A type-I single quadrature converter, an embodiment 1611 in FIG. 9, may be used in conversion 1530 to provide an image rejection of 30 to 40 dB. The design requirement of RF BP filter 1516 may be consequently reduced by 30 to 40 dB. Practically, a bank of switchable RC and LC bandpass filters is designed for RF bandpass filter 1516. The center frequency of IF1 1529 may also be defined lower than the upper bound of the frequency band, for example, as low as 400 MHz, for some applications, like for cable TV reception. Although lowering the center frequency of IF1 1529 can typically improve the I/Q matching in second-stage zero-IF downconverter 1535, it increases the design constraint of RF BP filter 1516 because the image offset from the desired signal at RF stage 1519 is smaller, and it may cause some leakage of IF1 1529 at RF input port 1500.

After first-stage conversion 1530, polyphase filter 1532 is optionally used to suppress a sideband of the (first-order) image in next-stage zero-IF downconversion 1535 and possibly sidebands of some high-order images. Bandpass filter 1533 then suppresses the high-order images and some strong interference signals. Positions of filters 1532 and 1533 are exchangeable. Zero-IF double quadrature downconverter 1535 downconverts the desired signal in IF1 stage 1529 to baseband 1549. It also rejects the (first-order) image. Benefited from zero-IF downconversion 1535, BP filter 1533 is now only for suppressing the high-order images, thus it can be integrated on chip using a low-quality filter design. If there is a need to further relax the design of BP filter 1533, double quadrature MIR converter 8500 in FIG. 6 can be used in zero-IF downconversion 1535.

The remaining circuit blocks (after zero-IF downconversion 1535) in triple-conversion tuner 1509 in FIG. 24 are similar to the corresponding circuit blocks in dual-conversion tuner 1501 in FIG. 1. Therefore the previous analysis and description of dual-conversion tuner 1501 in FIG. 1 are applicable to these remaining blocks in triple-conversion tuner 1509 in FIG. 24.

The unique structure of baseband stage 1549 allocated just before an output IF stage 1559 provides an important advantage in solving the issues of DC-offset and I/Q mismatch in baseband 1549. Baseband lowpass filter 1537 filters baseband signal 1549. Note that functionalities of baseband LP filter 1537 are similar to those of baseband LP filter 1536 and PGA 1541 in FIG. 1. Double quadrature upconverter 1546, an embodiment 1651 shown in FIG. 8, upconverts baseband signal 1549 to output IF 1559 of 44 MHz, 36 MHz or others. The uses of output IF stage 1559 and functional circuits in it reduce the gain requirement in baseband 1549, and only a small gain of 10 to 30 dB may be necessary. Thus the impact of DC-offsets from baseband circuitry 1537 and zero-IF downconverter 1535 on the linear operation of baseband circuitry 1537 is reduced significantly. Double quadrature MIR converter 8500 in FIG. 6 may apply to upconversion 1546 to suppress harmonics in output IF signal 1559 caused by switching upconversion 1546 to potentially reduce design constraints of filters 1537 and 1556.

Next to upconverter 1546, polyphase filter 1551 is optionally used to provide image suppression of 30 to 40 dB and convert the quadrature signal to a real signal. Bandpass filter 1556 is then designed for channel selectivity, suppression of interference signals and anti-aliasing filtering for an A/D converter in accordance with specifications of an application. A PGA in PGA/Driver block 1558 amplifies the desired signal according to AGC signal 1560. A driver in PGA/Driver block 1558 provides an adequate output IF interface 1599 to interface with the A/D converter or an analog TV demodulator.

Three reference signal generators 1572, 1573, 1581 provide reference (or LO) signals 1576, 1577, 1585. Crystal oscillator 1580 generates low phase noise reference-source frequency 1570. The frequency of crystal oscillator 1580 may be fine-tuned by AFC signal 1590. First reference signal generator 1572 having a tunable frequency synthesizer provides tunable-frequency quadrature reference signal 1576 for channel tuning.

For defining center frequencies of IF1 1529 and output IF 1559, a preferable solution is presented as follows. For a predetermined center frequency of output IF 1559, the center frequency of IF1 1529 may be such defined that the center frequency of output IF 1559 is equal to the center frequency of IF1 1529 divided by multiples of divide-by-2 or by a combination of dividers of divide-by-2, divide-by-3, divide-by-5, divide-by-7, and divide-by-11. Then, third quadrature reference signal 1585 may be derived from frequency division of second quadrature reference signal 1577 using these prior art dividers. To generate the quadrature signal of third reference signal 1585, a last-stage divider needs to generate a quadrature reference signal of 50% duty-cycle using, for example, a cascade of a four-phase divide-by-2 divider and a divide-by-2 divider. Due to the frequency division, derived third quadrature reference signal 1585 normally possesses lower phase noise than second quadrature reference signal 1577 when the dividers are properly designed to have minimal time jitter. Here is an example. If the center frequency of output IF 1559 is 36 MHz, then the center frequency of IF1 1529 can be defined as 1152 MHz. Then third quadrature reference signal 1585 can be derived from second reference signal 1577 divided by four divide-by-2 dividers and one four-phase divide-by-2 divider.

Another preferred embodiment of an integrated tuner of triple-conversion architecture in accordance with the present invention is derived from triple-conversion tuner 1509 in FIG. 24 by replacing baseband 1549 with a low-IF stage, where the center frequency of the low-IF is in the range of one half to one of the channel spacing of RF signal 1500. Baseband filter 1537 is then a low-IF bandpass filter. A low-IF polyphase filter may be placed prior to the low-IF bandpass filter to suppress an image in the low-IF stage.

For some applications, it is reasonable to have an integrated tuner design to include a combination of the integrated tuners disclosed by this invention and possibly other prior art integrated tuners and to switch to one tuner for a specific RF signal source, manually or automatically. Here is an example of designing a tuner for both terrestrial and cable TVs and for both digital and analog TV signals. A combination of first-stage zero-IF downconversion, dual-conversion tuner 1501 in FIG. 1 and first-stage low-IF downconversion, dual-conversion tuner 1508 in FIG. 22 are selected. The frequency of output IF 1559 is assumed as 44 MHz. When a digital terrestrial TV is received, tuner 1501 is switched on; when a digital or analog cable TV is received, tuner 1508 is switched on. When an analog terrestrial TV is received, either tuner 1501 or tuner 1508 is switched on, partially depending on circuit design performance and process technology used. Automatic switching control signal may be generated in demodulators according to modulation information or using messages from upper layers in digital systems. Different frequencies of an IF output may also be provided and switched for different demodulators.

The integrated tuners disclosed by this invention can be used for TV standards like NTSC, PAL, SECAM, DVB-T, DVB-H, ATSC, ISDB, DMB, MediaFLO, incoming new digital TV standards, etc., and other applications fully or partially using the frequency band of 50 to 880 MHz or 40 MHz to 1 GHz and having a channel spacing of 6 to 8 MHz or smaller, like in a FM radio broadcast. Examples are voice of IP, video conferencing, PC applications, etc. They can also be used for TV applications in other frequency bands or ranges, like DVB-H in the U.S. L-Band, a channel of 1670-1675 MHz, and possibly in the L-Band spectrum for European mobile TV broadcast. Modulation schemes described are only exemplary with this invention not being limited in scope to any particular modulation scheme.

As mentioned previously, the MHOIR switching mixers and MIR converters disclosed in this invention are the mixers and converters which may be used for RF receivers, any RF receivers for terrestrial, cable, wireless, etc. applications. These wireless applications are, for example, GSM, WCDMA, WLAN, and WPAN. Due to small ratios of frequency bands and centers of the frequency bands in these wireless systems, which are much smaller than those of terrestrial and cable TV systems, it is feasible to use external filters, even SAW filters, at the inputs or RF front-stages of the wireless RF receivers to suppress strong interference signals. So the uses of the MHOIR switching mixers and MIR converters in these wireless RF receivers may not be as critical as in the terrestrial and cable TV tuners.

Although the present invention and some embodiments have been described in detail, it should be understood that the aforesaid embodiments illustrate rather than limit the invention, and that various other embodiments can be made herein without departing from the spirit or scope of the invention as defined by the appended claims. Although the description above contains many requirements and specifications, these should not be construed as limiting the scope of the invention but as providing illustrations of some of the presently preferred embodiments of this invention. Thus the scope of the invention should be determined by the appended claims.

1-14. (canceled)

15. An integrated receiver comprising:
1. a multi-phase reference signal generator generating a multi-phase reference signal, of square-wave form, which has a plurality of phase components and a frequency;
2. a converter means for substantially rejecting at least one of major odd-number high-order (MONHO) images which comprise third-, fifth-, seventh- and ninth-order images in an RF signal, wherein the converter means has a signal input coupled to the RF signal, has a multi-phase reference input coupled to the multi-phase reference signal, and generates an IF signal at an output; the converter means comprises:
1) a plurality of switching mixers having signal inputs coupled to the signal input of one of real and quadrature signal formats, each having a reference input coupled to a phase component of the multi-phase reference input;
2) a plurality of weighted summing means each having inputs coupled to outputs of two or more of the switching mixers; wherein results of predetermined combinations of outputs of the weighted summing means are coupled to the output, of one of real and quadrature signal formats, of the converter means, wherein each of the combinations is one of direct passing, addition, and subtraction; and
3) ratios of products of gains of the switching mixers and weights of the corresponding inputs of the weighted summing means are predetermined substantially in accordance with formulas for full cancellation of at least one of the MONHO images so that the converter means substantially rejects at least the one of the MONHO images at the output thereof.

16. The integrated receiver of claim 15 wherein the converter means is a converter means for substantially rejecting the third- and fifth-order images; the multi-phase reference input has components of 45°, 0°, −45°, −90° and −135°, of relative phases; wherein the ratios of the products of the gains of the switching mixers having the 45°, 0°, −45°, −90° and −135° components and the weights of the corresponding inputs of the weighted summing means are predetermined, at least substantially, as 1, √2, 1, √2 and 1, respectively so that the converter means substantially rejects the third- and fifth-order images.

17. The integrated receiver of claim 15 wherein the converter means is a converter means for substantially rejecting the third- and fifth-order images; the multi-phase reference input has components of 45°, 0° and −45°, of relative phases; wherein the ratios of the products of the gains of the switching mixers having the 45°, 0° and −45° components and the weights of the corresponding inputs of the weighted summing means are predetermined, at least substantially, as 1, √2 and 1, respectively so that the converter means substantially rejects the third- and fifth-order images.

18. The integrated receiver of claim 16 wherein the switching mixers are grouped into two or four mixer modules for substantially rejecting the third- and fifth-order images, each of the mixer modules including three of the switching mixers and one of the weighted summing means; wherein each of the mixer modules has a signal input coupled to the signal inputs of the three switching mixers, has relative-phase 45°, 0° and −45° components of a three-phase reference input coupled to the reference inputs of the three switching mixers, respectively, and has an output coupled to the output of the weighted summing means, wherein the outputs of the three switching mixers are coupled to three inputs of the weighted summing means, respectively, wherein the ratios of the products of the gains of the switching mixers having the relative-phase 45°, 0° and −45° components and the weights of the corresponding inputs of the weighted summing means are predetermined, at least substantially, as 1, √2 and 1, respectively, so that the mixer module substantially rejects the third- and fifth-order images.

19. The integrated receiver of claim 18 wherein the signal input of the converter means is a real signal input, the output of the converter means is a quadrature output; the converter means has the two mixer modules; wherein the signal inputs of the mixer modules are coupled to the real signal input of the converter means; two triplets of the relative-phase 45°, 0° and −45° components of the three-phase reference inputs of the two mixer modules are coupled respectively to a triplet of the 45°, 0° and −45° components and a triplet of the −45°, −90° and −135° components of the multi-phase reference input; the two mixer modules output respectively I and Q components of the quadrature output of the converter means.

20. The integrated receiver of claim 18 wherein the signal input of the converter means is a quadrature signal input, the output of the converter means is a quadrature output; the converter means has the four mixer modules; wherein the signal inputs of first and second mixer modules are coupled to an I component of the quadrature signal input of the converter means, the signal inputs of third and forth mixer modules are coupled to a Q component of the quadrature signal input of the converter means; the relative-phase 45°, 0° and −45° components of the three-phase reference inputs of the first and forth mixer modules are coupled to the 45°, 0° and −45° components of the multi-phase reference input, respectively, the relative-phase 45°, 0° and −45° components of the three-phase reference inputs of the second and third mixer modules are coupled to the −45°, −90° and −135° components of the multi-phase reference input, respectively; wherein a predetermined one of the outputs of the third and second mixer modules is inverted; a result of adding the outputs of the first and third mixer modules and a result of adding the outputs of the second and forth mixer modules are respectively I and Q components of the quadrature output of the converter means.

21. The integrated receiver of claim 17 wherein the signal input of the converter means is a quadrature signal input, the output of the converter means is a quadrature output; wherein the switching mixers are grouped into two mixer modules for substantially rejecting the third- and fifth-order images, each of the mixer modules including three of the switching mixers and one of the weighted summing means; wherein each of the mixer modules has a signal input coupled to the signal inputs of the three switching mixers, has relative-phase 45°, 0° and −45° components of a three-phase reference input coupled to the reference inputs of the three switching mixers, respectively, and has an output coupled to the output of the weighted summing means, wherein the outputs of the three switching mixers are coupled to three inputs of the weighted summing means, respectively, wherein the ratios of the products of the gains of the switching mixers having the relative-phase 45°, 0° and −45° components and the weights of the corresponding inputs of the weighted summing means are predetermined, at least substantially, as 1, √2 and 1, respectively; wherein the signal inputs of the two mixer modules are coupled respectively to I and Q components of the quadrature signal input of the converter means; the relative-phase 45°, 0° and −45° components of the three-phase reference inputs of the two mixer modules are coupled to the 45°, 0° and −45° components of the multi-phase reference input, respectively; the two mixer modules output respectively I and Q components of the quadrature output of the converter means.

22. (canceled)

23. The integrated receiver of claim 19 wherein the frequency of the multi-phase reference signal is tunable for tuning of a selected channel of the RF signal in a frequency band; wherein a center frequency of the IF signal is 0 Hz, the IF signal is a baseband signal, and the converter means is a zero-IF downconverter means; the integrated receiver further comprises:
1. an RF filter coupled to the RF signal for suppressing unwanted signals, wherein the signal input of the zero-IF downconverter means is coupled to the RF signal by the RF filter; and
2. a baseband filter coupled to the quadrature output of the zero-IF downconverter means for filtering the baseband signal;
whereby the zero-IF downconverter means substantially relaxes the RF filter design.

24. The integrated receiver of claim 20 wherein the frequency of the multi-phase reference signal is tunable for tuning of a selected channel of the RF signal in a frequency band; wherein a center frequency of the IF signal is 0 Hz, the IF signal is a baseband signal, and the converter means is a zero-IF downconverter means; the integrated receiver further comprises:
1. an RF filter coupled to the RF signal for suppressing unwanted signals;
2. an RF polyphase filter for suppressing at least a first-order image, having a real input coupled to an output of the RF filter, having a quadrature output coupled to the quadrature signal input of the zero-IF downconverter means; and
3. a baseband filter coupled to the quadrature output of the zero-IF downconverter means for filtering the baseband signal.

25. (canceled)

26. The integrated receiver of claim 19 wherein the frequency of the multi-phase reference signal is tunable for tuning of a selected channel of the RF signal in a frequency band; wherein a center frequency of the IF signal is predetermined approximately in a range of one half to one of a channel spacing of the RF signal, the IF signal is a low-IF signal, and the converter means is a low-IF downconverter means; the integrated receiver further comprises:
1. an RF filter coupled to the RF signal for suppressing unwanted signals, wherein the signal input of the low-IF downconverter means is coupled to the RF signal by the RF filter; and
2. a low-IF filter coupled to the quadrature output of the low-IF downconverter means for filtering the low-IF signal;
whereby the low-IF downconverter means substantially relaxes the RF filter design.

27. The integrated receiver of claim 20 wherein the frequency of the multi-phase reference signal is tunable for tuning of a selected channel of the RF signal in a frequency band; wherein a center frequency of the IF signal is predetermined approximately in a range of one half to one of a channel spacing of the RF signal, the IF signal is a low-IF signal, and the converter means is a low-IF downconverter means; the integrated receiver further comprises:
1. an RF filter coupled to the RF signal for suppressing unwanted signals;
2. an RF polyphase filter for suppressing at least a first-order image, having a real input coupled to an output of the RF filter, having a quadrature output coupled to the quadrature signal input of the low-IF downconverter means; and
3. a low-IF filter coupled to the quadrature output of the low-IF downconverter means for filtering the low-IF signal.

28. (canceled)

29. The integrated receiver of claim 23 wherein the RF signal takes the form of at least one of a terrestrial TV signal, a cable TV signal, a digital data signal transmitted over a cable system, a terrestrial digital data signal, and a broadcast audio signal; the integrated receiver further comprises:
1. a second reference signal generator generating a second reference signal;
2. a second converter having a signal input coupled to the baseband filter and a reference input coupled to the second reference signal, and generating a second IF signal at an output, wherein a predetermined center frequency of the second IF signal is lower than a lower bound of the frequency band; and
3. a second IF filter having an input coupled to the output of the second converter for filtering the second IF signal.

30. The integrated receiver of claim 24 wherein the RF signal takes the form of at least one of a terrestrial TV signal, a cable TV signal, a digital data signal transmitted over a cable system, a terrestrial digital data signal, and a broadcast audio signal; the integrated receiver further comprises:
1. a second reference signal generator generating a second reference signal;
2. a second converter having a signal input coupled to the baseband filter and a reference input coupled to the second reference signal, and generating a second IF signal at an output, wherein a predetermined center frequency of the second IF signal is lower than a lower bound of the frequency band; and
3. a second IF filter having an input coupled to the output of the second converter for filtering the second IF signal.

31-33. (canceled)

34. A method of processing an RF signal in an RF receiver comprising the steps of:
1. generating a multi-phase reference signal, of square-wave form, which has a plurality of phase components and a frequency;
2. mixing the RF signal with a phase component of the multi-phase reference signal in each of a plurality of switching mixers;
3. summing outputs of two or more of the switching mixers in each of a plurality of weighted summer means, wherein the outputs of the switching mixers are weighted prior to the summing operation of the outputs of the switching mixers in the weighted summer means;
4. combining outputs of the weighted summer means to thereby generate an IF signal of one of real and quadrature signal formats at an IF output, wherein the combining operation of the outputs of the weighted summer means includes at least one of direct passing, adding and subtracting operations of the outputs of the weighted summer means; and
5. predetermining ratios of products of gains of the switching mixers and weights of corresponding inputs of the weighted summer means such that at least one of major odd-number high-order (MONHO) images which comprise third-, fifth-, seventh- and ninth-order images in the RF signal is rejected at the IF output.

35-36. (canceled)

37. The method of claim 34 wherein the multi-phase reference signal has components of 45°, 0°, −45°, −90° and −135°; wherein the ratios of the products of the gains of the switching mixers having the 45°, 0°, −45°, −90° and −135° components and the weights of the corresponding inputs of the weighted summing means are, at least approximately, 1, √2, 1, √2 and 1, respectively.

38. (canceled)

39. The method of claim 34 wherein the multi-phase reference signal has components of 45°, 0° and −45°; wherein the ratios of the products of the gains of the switching mixers having the 45°, 0° and −45° components and the weights of the corresponding inputs of the weighted summing means are, at least approximately, 1, √2 and 1, respectively.

40. (canceled)

41. The method of claim 34 wherein a center frequency of the IF signal is predetermined approximately in a range of 0 Hz to one of a channel spacing of the RF signal; wherein the step of mixing the RF signal with the phase component of the multi-phase reference signal is a downconverting; comprising the further steps of:
1. upconverting the IF signal to a second IF signal, wherein a predetermined center frequency of the second IF signal is greater than the center frequency of the IF signal; and
2. generating a second reference signal for use in the upconverting of the IF signal to the second IF signal.

42. (canceled)

43. An integrated tuner for receiving an RF signal, in a frequency band, which takes the form of at least one of a terrestrial TV signal, a cable TV signal, a digital data signal transmitted over a cable system, a terrestrial digital data signal, and a broadcast audio signal, comprising:
1. a first reference signal having a first frequency;
2. a second reference signal having a second frequency;
3. a first converter having a signal input coupled to the RF signal and a reference input coupled to the first reference signal, generating a baseband signal at an output; and
4. a second converter having a signal input coupled to the baseband signal and a reference input coupled to the second reference signal, generating a second IF signal at an output, wherein the second IF signal has a center frequency lower than a lower bound of the frequency band;
whereby the first converter substantially relaxes design of RF stage circuitry, the second converter provides the second IF signal according to an IF interface requirement.

44. The integrated tuner of claim 43 wherein the first reference signal is tunable for tuning of a selected channel of the RF signal; the integrated tuner further comprises:
1. an RF filter having an input coupled to the RF signal for suppressing unwanted signals in the RF signal, wherein the signal input of the first converter is coupled to the RF signal by the RF filter;
2. a baseband filter coupled to the output of the first converter for filtering the baseband signal, wherein the signal input of the second converter is coupled to the baseband signal by the baseband filter;
3. a second IF filter coupled to the output of the second converter for filtering the second IF signal;
4. a first reference signal generator generating the first tunable reference signal; and
5. a second reference signal generator generating the second reference signal.

45-51. (canceled)

52. The integrated tuner of claim 44 wherein the first converter is a converter module for substantially rejecting at least one of major odd-number high-order (MONHO) images which comprise third-, fifth-, seventh- and ninth-order images in the RF signal; wherein the first reference signal is a multi-phase reference signal having a plurality of phase components; the reference input of the converter module is a multi-phase reference input which is coupled to the multi-phase reference signal; the converter module comprises:
1. a plurality of switching mixers having signal inputs coupled to the signal input of one of real and quadrature signal formats, each having a reference input coupled to a phase component of the multi-phase reference input;
2. a plurality of weighted summing means each having inputs coupled to outputs of two or more of the switching mixers; wherein results of predetermined combinations of outputs of the weighted summing means are coupled to the output of the converter module, wherein each of the combinations is one of direct passing, addition, and subtraction; and
3. ratios of products of gains of the switching mixers and weights of the corresponding inputs of the weighted summing means are predetermined substantially in accordance with formulas for full cancellation of at least one of the MONHO images so that the converter module substantially rejects at least the one of the MONHO images at the output thereof.

53-74. (canceled)
